(19) United States
(12) Patent Application Publication
(10) Pub. No.: US 2018/0305226 A1
(43) Pub. Date: Oct. 25, 2018

(54) Method and Apparatus for Water Purification

(71) Applicants: Ryan Simpson, New Haven, CT (US); Paulina Kaminski, New Haven, CT (US); Allec Willis, New Haven, CT (US)

(72) Inventors: Ryan Simpson, New Haven, CT (US); Paulina Kaminski, New Haven, CT (US); Allec Willis, New Haven, CT (US)

(21) Appl. No.: 15/950,121

(22) Filed: Apr. 10, 2018

Related U.S. Application Data
(60) Provisional application No. 62/488,262, filed on Apr. 21, 2017.

(51) Int. Cl. C02F 1/32

(52) U.S. Cl. CPC C02F 1/325; C02F 2201/328; C02F 2201/3228; C02F 2201/3223; C02F 2303/04; C02F 2201/3222; C02F 2301/026

(57) ABSTRACT

A portable, sustainable, and multi-scale water chamber utilizing the helical spiraling of a hand- or automated-screw structure encircling around an ultraviolet light to maximize the ultraviolet transmittance and minimize the exposure time for thorough ultraviolet germicidal water purification.

### RELATED APPLICATIONS

This application claims the benefit of the filing date of U.S. provisional patent application No. 62/488,262, filed Apr. 21, 2017, entitled “Method and Apparatus for Water Purification”, the entire contents of which are incorporated by reference under 37 C.F.R. § 1.57.

### TECHNICAL FIELD

Embodiments of the invention relate to water purification, and in particular to a portable, sustainable, and multi-scale water chamber utilizing the helical spiraling of a hand- or automated-screw structure encircling around an ultraviolet light to maximize the ultraviolet transmittance and minimize the exposure time for thorough ultraviolet germicidal water purification.

### BACKGROUND

### Definitions

Within the subsection that follows, specific considerations have been given to the definitions and terminology that will be repeated within this application. Given both the specificity of this system's functionality in conjunction with the broadness of system operability, semantics are critical to ensure the full security of intellectual property. As such, all definitions that follow have been provided to ensure no discrepancy between the intentions and extent of claims within this application as compared to syntax possibly found beyond this application. Technical information, descriptions, and context-based explanations for the scientific theories of this device have been found from a selected group of sources. While all statements, explanations, and intellectual property regarding the creation of this design was independently developed by the researchers of this patent, credit and acknowledgement must be given to the academic resources used for researching this project. As such, we note specifically that the United States Environmental Protection Agency's Ultraviolet Disinfection Guidance Manual for the Final Long Term 2 Enhanced Surface Water Treatment academic resource and Wladyslaw Kowalski's Ultraviolet Germicidal Irradiation Handbook were used, referenced, and in some cases directly sourced/cited for information found in [0003] through [0039] and in [0050] through [0070]. While not specifically footnoted, some of the scientific reasonings and explanations are taken directly and near verbatim from these resources (including but not limited to the technical definitions offered below regarding ultraviolet irradiance and figures disclosed herein). With this in mind, specific definitions for important terminology will include:

Ballast—an electrical device that provides the proper voltage and current required to initiate and maintain the gas discharge within a ultraviolet lamp

Biodosimetry—a procedure used to determine the reduction equivalent dose (RED) of an ultraviolet reactor. This involves measuring the inactivation of a challenge microorganism after exposure to ultraviolet light in an ultraviolet reactor and comparing the results to the known ultraviolet dose-response curve of the challenge microorganism (determined via bench-scale collimated beam testing).

Dark Repair—an enzyme-mediated microbial process that removes and regenerates a damaged section of DNA using an existing complementary strand of DNA. Dark repair refers to all microbial repair processes not requiring reactivating light.

The Calculated Dose Approach—this method uses a dose-monitoring equation to estimate the ultraviolet exposure dosage based on operation conditions (typically flow rate, ultraviolet intensity, and UVT). This equation may be developed by the ultraviolet manufacturers using numerical methods; however the US EPA recommends that systems use an empirical dose-monitoring equation developed through validation testing. During reactor operations, the ultraviolet reactor control system inputs the measured parameters into the dose-monitoring equation to produce a calculated dose.

Germicidal Range—the range of ultraviolet wavelength responsible for microbial inactivation in water (200 nm to 300 nm).

Inactivation—in the context of ultraviolet disinfection, a process by which a microorganism is rendered unable to reproduce, thereby rendering it unable to infect a host.

Low-Pressure (LP) Lamp—a mercury-vapor lamp that operates at an internal pressure of 0.13 to 1.3 Pascals (or between 2*10⁻⁵ and 2*10⁻⁴ PSI) and an electrical input of 0.5 W/cm². This results in essentially monochromatic light output at 254 nm.

Medium-Pressure (MP) Lamp—a mercury-vapor lamp that operates at an internal pressure of 1.3 and 13,000 Pascals (2 to 100 PSI) and electrical input of 50 to 150 W/cm². This results in a polychromatic (or broad spectrum) output of ultraviolet and visible light at multiple wavelengths, including wavelengths in the germicidal range.

Photorepair—a microbial repair process where enzymes are activated by light in wavelengths near the ultraviolet and visible range, thereby repairing ultraviolet induced damage. Photoreactivation requires the presence of light.

Required Dose—the ultraviolet dose required for a certain level of log inactivation.

UV Absorbance (A)—a measure of the amount of ultraviolet light that is absorbed by a substance (e.g. water, microbial DNA, lamp envelope, quartz sleeve) at a specific wavelength (typically 254 nm). This measurement accounts for absorption and scattering in the medium (water).

Fluence/UV Dose—the ultraviolet energy per unit area incident on a surface, typically reported in units of mJ/cm² or J/m². The ultraviolet dose received by a waterborne microorganism in a reactor vessel accounts for the effects on ultraviolet intensity of the absorbance of the water, absorbance of the quartz sleeves, reflection and refraction of light from the water surface and reactor walls, and the germicidal effectiveness of the ultraviolet wavelengths transmitted.

Fluence Rate/UV Intensity—the power passing through a unit area perpendicular to the direction of propagation. Ultraviolet intensity is used in this guidance manual to describe the magnitude of ultraviolet light measured by ultraviolet sensors in a reactor and with a radiometer in bench-scale ultraviolet experiments.

UV Reactor—the vessel or chamber where exposure to ultraviolet light takes place, consisting of ultraviolet lamps, quartz sleeves, ultraviolet sensors, quartz sleeve cleaning systems, and baffles or other hydraulic controls. The ultraviolet reactor also includes additional hardware for monitoring ultraviolet dose delivery, typically comprised of but not limited to ultraviolet sensors and UVT monitors.

UV Transmittance (UVT)—a measure of the fraction of incident light transmitted through a material (e.g. water sample or quartz). The UVT is usually reported for a wavelength of 254 nm and a pathlength of 1 cm. If an alternative pathlength is used, it should be specified or converted into units of cm⁻¹. UVT is often represented as a percentage and is related to the ultraviolet absorbance at a wavelength of 254 nm (e.g. A₂₅₄ and T₂₅₄).

Incidence Angle—the angle at which light hits a surface or, furthermore, the angle created between the straight-line photon stream against a material and the horizontal surface of that material. This angle is important for calculation of light propagation including absorption, refraction, reflection, and scattering.

Point-of-Exit—the means by which water has traveled through all other carrying mechanisms including but not limited to any aforementioned water resource in [0001] as well as any water purification system prior to the embodiments of the invention disclosed herein. As such, water has reached the last possible location of travel prior to dispersion among users or storage, thus making the term point-of-exit synonymous with the term point-of-use. These two terms will be used interchangeably in the application moving forward.

Point-of-Entrance—the starting location by which water begins to travel through all other carrying mechanisms including but not limited to any aforementioned water resource in

as well as any mobile carrying device. As such, this terminology is widely used to distinguish both the direct source from which water resources have been retrieved from as well as the means by which water transfers into a mobile carrying device.

Purification—the division of the removal of contaminant matter within water resources to include 7 subsections of water cleanliness: decontamination and disinfection. In the case of the former, decontamination refers to the removal of contaminants and particulate matter within water resources on a non-microbial level. Removal of these particulates would occur through the process of filtration. Disinfection refers to the removal or inactivation of pathogens and microbial organisms, accomplished via the efforts of the disclosed ultraviolet apparatus.

Completely Mixed Flow Reactor (CMFR)/Completely Stirred-Tank Reactor (CSTR)—this water system is based on the premise that fluid particles that enter the reactor are instantaneously dispersed throughout the reactor volume. This means that any influent water into the reactor will be uniformly dispersed with fluid particles leaving the reactor in proportion to the statistical population and fluid profile of the influent fluid.

Plug Flow Reactor (PFR)—this water system is based on the premise that fluid particles are passed through a water treatment reactor and are discharged through the same sequence in which they enter the reactor. Each fluid particle remains within the reactor for an established hydraulic retention time inherent to that system's composition.

Ethnography—the descriptive work produced from research on the study and systematic recording of human cultures and human behaviors. More specifically, this assessment technique is utilized in determining the means by which individuals interact with one another and their surrounding environment.

Photochemical Reactions—a reaction initiated by the absorption of energy in the form of light. The consequence of the molecules' absorbing light is the creation of transient excited states whose chemical and physical properties differ greatly from the original molecules.

Oxidation Reactions—a chemical reaction where the molecule reacting loses electrons, resulting in the changing of the chemical properties of the molecule.

Filtration—any of various mechanical, physical, or biological operations that separate solids from fluids, dissolved liquids from liquids, or dissolved gases from liquids. This is accomplished by means including but not limited to adding media through which the fluid can pass.

Sustainability—the capacity to maximize the amount of resources utilized from the environment while causing the least possible damage to that environment. Thought, therefore, is given to both the short-term ramifications of an action within nature as well as the long-term durability of continually utilizing this resource to perform an act over time.

Versatility—the frequency of applications and market verticals for which a system can be utilized in a readily accessible, easily maintained, and convenient manner. In other words, this term refers to how broadly a system can be applied with the fewest alterations made to that system's functional components.

Baffling—an artificial obstruction for checking or deflecting the flow of solids, liquids, or gases. In this patent application, embodiments cover all modifications made to this continuous helical baffling component as well as any operative changes including but not limited to the automation of the baffling to turn irrespective of waterflow.

Equations

Within the subsection that follows, technical explanations have been given for the mathematical and scientific formulas utilized in the creation of this design. Recognizing that these calculations are both pertinent to the understanding of the design and also can be easily misconstrued, equations and explanations thereafter are introduced for two reasons. First, the equation is provided for which all calculations, assumptions, and strategic thinking regarding the baffling creation can be checked and justified. Given both the specificity of this system's functionality in conjunction with the broadness of system operability, following the mathematical and scientific reasoning is critical to ensure the full security of intellectual property. As such, all equations have been introduced with clearly marked images to ensure no discrepancy among the intentions, extent, and accuracy of claims within this application.

While listing equations can prove important for basic mathematical computations, it is equally as important to understand why certain equations are necessary and how the results of said equations impacted the generation of this system. As such, the second purpose of introducing these equations will be to provide what inherent assumptions have been made within each of the calculations that follow. With more explicit explanation on the functional and operable reasoning for evaluating this equation, we hope to protect the intellectual property behind the concept of our system's functional purpose. This means to say that the explanations inherent in the equations that follow mean to protect the inter-linkage between perceptions of the equations and the actual formulation of the product itself. We do not claim the equations themselves. Rather, we wish to express the interpretations and considerations arising from using these equations and protect the embodiments of the invention stemming from that point forward through the design creation and application.

Transmittance (T)—One of the most important equations for determining ultraviolet dose delivery is determining the transmittance of ultraviolet light as it passes through various media. In order to determine the ultraviolet dose intensity, one must determine what the transmittance of that light is across a specific area being measured. Furthermore, this equation shows how much ultraviolet light passing from the ultraviolet lamp will actually reach the microbes being inactivated by the light itself. With that in mind, the transmittance is calculated at the surface of the lamp (thus offering the highest irradiance of light entering the solution) and the inner surface of the ultraviolet reactor (thus offering the lowest irradiance of light exiting the solution). By taking the greatest possible irradiance loss into consideration, this calculation will ensure that the least amount of transmittance (and thus highest absorbance) is considered as the baseline for calculations. Under this parameter, the ultraviolet dose will be monitored in order to account for the worst possible irradiance loss within the system and thus ‘over-disinfect’ any microbes within a closer radius from the ultraviolet lamp.

A drawback to this assumption, however, is that with the greatest irradiance loss being considered as the baseline, the ultraviolet reactor may not take into account the actual amount of irradiance emitted from the ultraviolet lamp. This assumption can thus result in minimizing the amount of radiation reaching the walls of the ultraviolet reactor than in actuality. Such an underestimate could result in creating a “hot-box” reactor: the irradiation could permeate through the reactor walls and pose safety hazards to workers handling the system. With that in mind, the invention errs on the side of caution in terms of material thickness for the final reactor walls developed. This patent application therefore covers any modification made to the ultraviolet reactor materials to ensure high ultraviolet absorbance and wall thicknesses greater than or equal to those necessary to withstand calculated transmittance by this equation. The equations for transmittance can be found below:

The absorption spectrum is typically measured by beaming light through a transparent solution containing microbes or molecules and comparing it against the pure solution. The transmittance (or transmissivity), T, of a solution is defined as:

$$T = \frac{I}{{I}_{0}} \qquad ( 2.1 )$$

where

I=irradiance of light exiting the solution, W/m²

I₀=irradiance of light entering the solution, W/m²

Photochemical Absorption and Photochemical Reactivation—the absorption of photons is pertinent for determining both the inactivation level of microbial organisms and the reactivation rates found in the process of photo-repair (or photo-reactivation). These calculations serve as a means of determining the efficiency of the ultraviolet disinfection technique on the target microbes. In other words, these equations map whether ultraviolet light photons have been absorbed by the DNA/RNA structures of target microbes (photochemical absorption) and to what extent those microbes have been able to resist this treatment effect (photo-reactivation). In the case of the former, these equations are dictated by two Laws of Photochemistry: 1) light must be absorbed by a molecule before any photochemical reactions can occur; and 2) absorbed light may not necessarily result in a photochemical reaction, but if it does, then only one photon is required for each molecule affected. As these laws show, photochemical absorption is determined strictly upon the probability that a light photon of the proper energy level interacts with the surface of a microbe. Furthermore, this indicates that photo-reactivation is determined by both the probability of a photon being absorbed by a molecule and the probability that the absorbed light induces a photochemical reaction. With these varying probabilities, it becomes evident whether a system design is more conducive to some microbe colonies than others. By considering these two properties in tandem, microbe populations can be better identified for their adaptability and resilience to disinfection techniques. Additionally, to maximize the probability of successful ultraviolet light interactions, a design was considered that could maximize the irradiance of the light without causing water to lie dormant. As such, the considered baffling structure offers an additional service outside those aforementioned in [0001] namely to increase the probability for successful collisions between ultraviolet light photons and microbes' DNA/RNA structures.

### 2.6 Quantitative Evaluation of Photoreactivation

To evaluate the effect of photoreactivation, the percentage photoreactivation was computed, defined (Lindenauer and Darby, 1994) as follows:

$$Percentage photoreactivation ( \% ) = \frac{( {N}_{p} - N )}{( {N}_{0} - N )} \times 100 \%$$

Here, Nₚ=cell number of photoreactivated sample (CFU/mL),
N=immediate survival after UV disinfection (CFU/mL),
N₀=cell number before UV disinfection (CFU/mL).

The First Law of Photochemistry (Grotthus-Draper Law) states that light must be absorbed by a molecule before any photochemical reactions can occur. The Second Law of Photochemistry (Stark-Einstein Law) states that absorbed light may not necessarily result in a photochemical reaction but if it does, then only one photon is required for each molecule affected (Smith and Hanawalt 1969). Since not every quantum of incident energy is absorbed by a molecule, there is an absorption efficiency that describes photochemical absorptivity. This efficiency is called quantum yield, Φ, and it is defined as:

$$Φ = \frac{{N}_{c}}{{N}_{p}} \qquad ( 2.8 )$$

where

N_{c}=Number of molecules reacting chemically

Nₚ=Number of photons absorbed

The quantum yield is computed from the inactivation cross-section divided by the absorption cross-section as follows:

$$Φ = \frac{σ}{S} \qquad ( 2.9 )$$

where

σ=inactivation cross-section, m²/photon

S=absorption cross-section, m²/photon

Ultraviolet Exposure Dosage (D)—one of the most important equations in the composition of this ultraviolet reactor is determining the amount of ultraviolet irradiance a microbe is exposed to. As noted in [0035], the deactivation of a microbe is contingent upon the number of photons absorbed by that microbe's DNA/RNA structure. These photons are directly related to the intensity of the ultraviolet light dosage on the microbe. Ultimately, this exposure dosage is impacted by two primary factors (with an unexhausted potential for secondary factors). The first factor is the influence of the light's irradiance, or the amount of irradiative flux moving through a flat, cross-sectional area of water (i.e. ultraviolet intensity). Ideally, this cross sectional area will be placed at the farthest edge of the reactor to cause the calculation to be designed for the lowest possible inactivation level. Furthermore, the irradiance shows how an input level of power can have an increased impact on smaller ultraviolet reactor scales of size (i.e. comparing the power of 1 W/m² compared to 1 W/cm²). The second factor influencing ultraviolet exposure dosages (synonymous to ultraviolet dosage delivery) is exposure time, or how long a microbe typically experiences the full magnitude of the irradiation noted. This exposure time transforms the calculation from power per cross sectional area to energy per cross sectional area, enabling more clarity in understanding the exposure of photons per cross sectional area for microbes.

### 3.3 UV Exposure Dose (Fluence)

Microbes exposed to UV irradiation are subject to an exposure dose (fluence) that is a function of the irradiance multiplied by the exposure time, as follows:

D=Eₜ·I_{R} (3.1)

where

D=UV exposure dose (fluence), J/m²

Eₜ=exposure time, sec

I_{R}=Irradiance, W/m²

Non-Collimated Beam Irradiance (I)—while the above measurement in [0035] provides an assessment of the dose delivered depending upon the irradiance experienced across certain intensities and depths of emission, the irradiance can also be predicted using another formula. By knowing the length of the cylindrical UV lamp used and the distance between the lamp and farthest differentiable surface of disinfection, the fraction of irradiance reaching that cross sectional area can be discovered. This fraction provides the view factor for any point along a lamp, with the irradiance experienced uniformly across each of these individual cross sectional areas. With this view factor computed, the irradiance field can then be applied to any functional distance from a lamp to determine the surface-felt irradiance of the UV lamp. Dividing the total germicidal output of the lamp (i.e. taking into consideration the decreased efficiency between electrical power supplied and ultraviolet light created) by the surface area of the lamp, the total irradiance rate of the lamp can be determined in full. As the view factor is evaluated according to centimeter units of distance, this overall irradiance rating is in the value of microwatts per square centimeter (μW/cm²). To note, this formula calculates the ultraviolet dosage at the least dose delivered point within the ultraviolet reactor. The use of this equation, therefore, provides the absolute worst possible irradiance from the most divergent beam within the reactor. Such an estimate provides the least exposure time required to disinfect water at the farthest distance away from the ultraviolet light source.

The parameters in Eq. (7.1) are defined as follows:

$$H = x / r$$

$$L = l / r$$

$$X = {( 1 + H )}^{2} + {L}^{2}$$

$$Y = {( 1 - H )}^{2} + {L}^{2}$$

$$M = \sqrt{\frac{H - 1}{H + 1}}$$

where

l=length of the lamp segment (arclength), cm

x=distance from the lamp, cm

r=radius of the lamp, cm

With reference to FIG. 14, the fraction of radiative irradiance that leaves the cylindrical body and arrives at a differential area (Modest 1993) is:

$$F = \frac{L}{π H} [ \frac{1}{L} ATAN ( \frac{L}{\sqrt{{H}^{2} - 1}} ) - ATAN ( M ) + \frac{X - 2 H}{\sqrt{XY}} ATAN ( M \sqrt{\frac{X}{Y}} ) ] \qquad ( 7.1 )$$

The irradiance field as a function of distance from the lamp axis is simply the product of the surface irradiance and the view factors, where the surface irradiance is computed by dividing the UV power output by the surface area of the lamp:

$$I = \frac{{E}_{uv}}{2 π rl} {F}_{total} \qquad ( 7.2 )$$

where Eᵤᵥ=UV power output of a lamp, μW.

Microbial Decay—once successfully determining the exposure dosage necessary to inactivate a microbe, two different calculations can be conducted to evaluate the success rate of the inactivation. The first of these calculations, the single-stage decay model, predicts the probable effectiveness of ultraviolet irradiation according to literature-reviewed rate constant values. Furthermore, this calculation attempts to quantify the expected survival rate of a microbial population according to the typical reaction of that microbe to a certain level of UV irradiance. This equation can be applied to any number of target microorganisms desired for inactivation, explaining the effectiveness of a reactor on disinfection for different microbial populations. In the case of the single-stage decay, this equation follows a standard first order decay pattern, most prominently found through the second log inactivation of a target microbe. In contrast, the two-stage decay model occurs when a binary decay rate is identified with microbes inactivating at two different rates according to two different inactivation resistance levels. Such resistance can be made applicable across an even greater number of inactivation resistance levels, denoted as shoulder curves, where the rate of survival is contingent upon exponential decaying of a microbe over time. In any of these models, the underlying purpose is to predict the effectiveness of inactivation expected within the UV reactor.

### 3.4 Single Stage Decay

The primary model used to evaluate the survival of microorganisms subject to UV exposure is the classical exponential decay model. This is a first-order decay rate model and is generally adequate for most UVGI design purposes provided the UV dose is within first order parameters. This is because disinfection rates of 90-90% can generally be achieved in the first stage of decay, and this is adequate for most design purposes. With few exceptions, a D₉₀ value defines the first stage of decay for bacteria and viruses. The D₉₀ value typically remains accurate up to a D₉₉ or even higher, but extrapolation beyond this point is not always valid.
The single stage decay equation for microbes exposed to UV irradiation is:

S=e^{-kD} (3.2)

where

S=Survival, fractional

k=UV rate constant, m²/J

S=(1−f)e^{-k}^{₁}^{D}+fe^{-k}^{₂}^{D} (3.3)

where

f=UV resistant fraction (slow decay)

k₁=first stage rate constant, m²/J

k₂=second stage rate constant, m²/J

S(t)=1−(1−e^{-kD})ⁿ (3.4)

where n=multitarget exponent

Microbial Decay Constants (k)—in order to determine these calculations, one must have a decay constant available for the evaluation of microbial inactivation. These rate constants are established across the literature and determined via rigorous experimentation of one microbe under a variety of conditions and parameters. As noted above in [0037], these constants offer a more concrete capacity to predict the microbial decay of a microorganism. More importantly, these predictions can provide a general guideline for which future system functionality can be weighed against. If a reactor has been designed efficiently, one will notice that the actual rate of disinfection mirrors the disinfection anticipated. With this parallel, the reactor performs as expected and thus, the presumed constraints of the system function within the anticipated degree of error. Alternatively, strong disagreement between the predicted and actual values of the microbial inactivation will result from an unintended flaw of the reactor. In this case, a specific design parameter was rejected, ignored, or forgotten causing a deficiency to the larger reactor. In either showing, decay constants are imperative for predictive power in the disinfection model.

Given the difficulty of measuring surface level or airborne parameters during experimentation, many of the rate constants available are predictive for water-based microbes (both immersed in water or of high relative humidity). Take note, bacterial phages are often used for substitutes of animal viruses in activation experiments as the two have proven to show equivalence in value across experiments literature-wide. Overall, rate constants should be used more as a guideline for evaluating and predicting potential inactivation via ultraviolet light. In any experiment, rate constants can be impacted by a variety of factors including but not limited to microbe size, molecular weight of DNA/RNA, percentage of existing dimers, presence of enzyme repair mechanisms in the target microbe, and the refraction index of the ultraviolet light through the media (in this case, water).

Pathogen Log Inactivation Equation (logl)—whereas decay curves offer a more predictive measure for evaluating UV reactor efficacy, the inactivation equation provides the opportunity to evaluate the effectiveness of inactivation achieved within a reactor. By evaluating the number of colony forming units of microbes, one can determine at what rate microbes have been inactivated as a result of the ultraviolet reactor system. As with the rate constant calculations above, the equation below is dictated by the accuracy of the information one records. Additionally, the system design must be sure that the control conditions within an ultraviolet reactor remains constant throughout the course of the disinfection. If not held consistent, microbes may enter or exit the reactor without being recorded as activated or inactivated colony forming units. As the measurement is evaluated through milliliter samples collected across the entire inactivation period, effluent water can be taken at various intervals of disinfection to also determine the optimal residence time within the system. Such iterations of experimentation allows for more accurate determination of the logarithmic removal of microbes over a certain time interval that water spends within a reactor.

Calculate log I for each measured value of N (including zero-dose) and the common Nₒ identified in Step 1 using the following equation:

$$log I = log ( \frac{{N}_{o}}{N} ) \qquad Equation C .3$$

where:

Nₒ=The common Nₒidentified in Step 1 (pfu/mL)

N=Concentration of challenge microorganisms in the petri dish after exposure to UV light (pfu/mL)

Proof of Need—Ethnography Assessment

Clean water serves as a fundamental staple in our everyday lives. Though imperative for drinking, purified water resources are pinnacle to many processes at the intersection between sustainability (referring in this instance to climate change and environmental conditions therein), nutritional security (further evaluated in [0155] through [0156]), and public health (further evaluated in [0150] through [0152]). These intersections culminate with both short-term and long-term impacts that permeate into all aspects of daily living. Such repercussions expose every individual to a form of insecurity including but not limited to those relating to health, home convenience, agriculture, nutrition, public health/hygiene, and manufacturing processes. Amidst this complexity, there is an underlying necessity for clean water resources that can be applied in all walks of life. That said, water resources are also diminishing and the capacity to harvest said resources before ocean dispersal often goes unnoticed. Limitations in accessible drinking water include but are not limited to stressors on wastewater management systems, increased expenses on healthcare, reduced rates of education attendance, negative recharging of groundwater aquifers, or the reliance on irregular climate variations for agricultural production. With water resources ever-present but under-utilized, there stands an imperative opportunity for which pure water resources can be harvested for daily living endeavors.

By design, this invention achieves one action: the commodification of impure water resources. For clarification, commodification focuses predominantly on access: the ability to provide clean water to every individual and community. To do this, however, this invention accepts that present states of infrastructure and urban planning have largely solidified and will continue to largely dictate water transport systems. In most instances, water resources are most easily obtained through groundwater resources although applications do exist for diversified water capture. With that in mind, this initiative makes no distinction of the type of water resource utilized, recognizing public, private, and natural water resources as viable for capture and purification. By remaining broad in the profile and characteristics of this resource being captured, the invention disclosed herein offers both general applicability for operative locations and specificity as to the particular unique and innovative functions that this system provides. As such, this water purification system and any manipulations made therein must have the versatility to be implemented anywhere to remove any contaminant or microbe. Additionally, as this system offers innovative significance through its functionality and operability, this provisional patent application seeks ownership of any intellectual property utilizing the same conceptual, functional, operational, or systems thinking processes as disclosed herein.

It is with this aim, that the system discloses the three conceptual functions of the design following the three word mantra: versatile, sustainable, purified water. Through a simple scope, this conceptual, systems thinking recognizes that “the water problem” is much more complicated than one simple crisis. Water security, as noted above in [0040] and [0041], includes a series of problems and issues spanning across numerous issue areas and commercial market verticals. Additionally, such a simple scope respects the fact that many factors both directly and indirectly impact water security as does water security both directly and indirectly impact various environmental, social, economic, and numerous unspecified factors.

So how is this mantra applicable to the aforementioned claims in [0040] of necessity and opportunity for pure water resources? More importantly, how can versatile, sustainable, and purified water resources be achieved via this patented invention? These answers are what follow below with explanations of the patented invention's functionality described thereafter. With that said, the explanations below provide extensive insight and descriptive assessments as to how this invention's innovative design can create versatile, sustainable, purified water resources for a diversity of applications.

Purified Water: At present, many commercialized products and previous art identify water purification as the removal of contaminants, particulates, and other physical pollutants within water resources. This, however, is only half the story. As such, this invention particularly targets water purification via both the decontamination and disinfection of water resources. Though the embodiments relate to the technological innovation of a compact ultraviolet reactor, the technical specifications of this system includes the modularity to incorporate filtration-based devices. Thus, embodiments relate to the improved functionality or operational efforts taken to introduce a compact water filter of any description therein. Such inclusion includes but is not limited to the attachment of a filter onto the disinfection unit, introducing any fastening mate for the interlocking of the two structures, or any modifications to the sizing of this innovation to achieve the aforementioned purposes. By using a compact filter unit, water will be removed of contaminants and particulates while the small-scale, compact, ultraviolet water purification system disclosed herein will remove pathogens and microbial organisms. Using this two-unit system, our newly designed technology helps fill an unfound need for holistic water treatment and creates the opportunity for more purified water resource applications beyond the tap.

Sustainable Water: The formal definition for the term “sustainable” is offered in [0028]. When discussing sustainability, one must take into account both how the system will operate as well as how the system will function under uncontrolled, environmental conditions. With this in mind, the system design targets two critical functional/operational considerations: energy and longevity. Using an intricate system construction, this ultraviolet water purification system causes water to do the primary work in the system. Given such, only a very small ultraviolet light is necessary, enabling energy resources to be optimized for higher germicidal output. Utilizing a minimal amount of electrical power relative to the average energy demand necessary of a person per day, this technology harnesses the ability to maximize renewable 7 energy resources, particularly but not limited to those pertaining to solar power and hydroelectric power. With this on-site energy source, these systems can function irrespective of energy grid availability. Additionally, while attempting to minimize the more active system components of this invention (e.g. renewable energy usage), embodiments of the invention contemplate utilizing passive water transport or energy cultivation including but not limited to the implementation of an Archimedes Screw to pull water up the baffling system or gravity fed water systems for water flowing down the baffling system.

Still further, this disinfection lamp also does not serve as the limiting factor in the disinfection process, providing long-term durability by close regulation of electrical settings. Though the longevity of the ultraviolet light is contingent upon the manufactured product used, the system's design intentionally minimizes stressors placed on the ultraviolet light. This then allows for energy resources to be allocated more easily, with less energy, for features including but not limited to the use of cold cathodes and rapid start ballasts. By having an energy saving design, these lamp features can provide rapid successional powering on and off of the ultraviolet light, minimizing stressors placed on electrodes to increase the operating capacity of the ultraviolet light. Additionally, by reducing the time of operation through this invention design in combination with these light settings, this product can offer more functional uses over the same lamp operating hours. As such, our disinfection unit fulfills the need of providing complete water purification in a low-expense, resource-non-intensive manner. Rather than short-term mitigation, our project targets long-term water purification, focusing not on mitigating water insecurity but preventing it and sustaining pure water resource availability in the future.

Versatile Water: The formal definition for the term “sustainable” is offered in [0029]. Rather than manufacturing clean water, the final primary systems thinking and conceptual innovation of this product is its ability to redefine the problem of water insecurity from an issue of quality to an issue of access. With this change in perspective, our technology successfully repurposes contaminated water in a convenient, readily accessible, and easily maintained way. As such, the value of the product is not what resource is provided but how that resource can impact the livelihoods of individuals. As such, this system captures value by improving the versatility by which water can be purified and distributed. By targeting point-of-exit application, this technology optimizes the existing water storing and capturing infrastructure of any building, in any region, for any purpose. By minimizing the system components for both water purification units as well as renewable energy resources, this technology is also easily-maintained and operated, regardless of one's profession or skill level with the equipment. Recognizing that innovation stretches beyond the function of the technology, embodiments disclosed herein cover the application of said technologies across all verticals, purposes, and operations listed throughout this document. Such applications include but are not limited to the public health vertical, the medicinal vertical, the urban planning vertical, the agricultural/nutritional verticals, militaristic-related verticals, education-related verticals, female empowerment related verticals, natural disaster/humanitarian emergency related verticals, home improvement verticals, and manufacturing systems verticals explained in further detail from [0149] through [0162].

One consideration taken into account via an ethnography report conducted in Hyderabad, India was the functionality of the system in the state of stagnant or idle-flowing water. In the absence of movement, water becomes susceptible to dissolved oxygen, increasing the potential for microbial production. Recognizing this, the purification system has been designed to serve as one continuous design: two parts, connecting as one, under a continuous helical baffling structure. The continuity in the structuring of the baffle causes water to continue up or down the spiral irrespective of the influent flow of the water. With such a design, no standing water can remain within the helical design, preventing bioaccumulation of microbes due to residual water in the system. As the design implies to be used for a moving water resource (predominantly though not exclusively via horizontal kinetic flow, gravity fed vertical flow, or reverse flow via automated or passive screwing mechanisms), water pressure built up at the influent of the purification apparatus will also prevent residual flow. Additionally, this is why the systematic design intends to be utilized for the functional purification of flow-of-water implementation. At the same time, while this structure acts as one continuous design, the modularity of the design allows for these two components to be disassembled for cleaning, repair, maintenance, or replacement.

When taking into consideration the application of this design, ethnographic information from India alluded to the scope and extent by which such an invention can be impactful. While water may be thoroughly decontaminated and disinfected, the security of this sanitized water remains only if the apparatus holding the water also remains unsoiled. As was found in tracing community impacts of local water resources, many families and households may have retrieved very clean water that became contaminated in the process of travels or otherwise. Especially in the developing world with more insecure means of vehicular travel, water resources easily become soiled when traveling via automobile or carrying by hand. Alternatively, contamination also became quite ubiquitous for those individuals who did not wash out their mobile carrying containers prior to filling them. Recognizing this gap of water purification and treatment, this design's functionality and operability was particularly focused on point-of-exit disinfection. As such, we declare the boundary of intellectual property rights up to the termination point of the water through the baffling invention herein and all succeeding applications including but not limited to storage, consumption, or any other usage outlined within this document.

One final consideration informing the technical specifications from the ethnography report in Hyderabad is the need for modularity. While the model shown within this patent application articulates a small-scale system, evidence from observations abroad prove that such a small-scale design may in fact be inefficient. In the case of local marketplaces or urban infrastructure receiving large volumes of water at any given time, we found that this small scale baffling system may need to be modified for a higher volumetric capacity across a broader surface area. Recognizing the ease by which such an innovation could be expanded and replicated into a larger model, we seek the intellectual property domain of all modifications to the size and shape of this design. These modifications include but are not limited to the width of the container and baffling, the thickness of the container and baffling, the length of the container and baffling, and the number of rotations of the helical spiral. As such, embodiments of the invention span across all possible scalability from small, hand-held designs to large, manufacturing or high volume reactor designs. This notion of scale also connects to the ease of construction with each of the few components to this disinfection system having the ability to be individually replaced. This singularity at the component-by-component level allows for individual parts of the system to be changed without needing to replace the entirety of the system. Furthermore, additions to this system include but are not limited to the inclusion of micro-sensors, micro-controllers, thermometers, or other quantitative monitoring and evaluation technologies and thus are encompassed within the functional design (and intellectual property domain) of this invention.

Background—Germicidal Irradiance

What follows includes basic and general information regarding the underlying properties related to ultraviolet purification in water, particularly focusing on germicidal irradiance. This information provides a layperson explanation for the scientific explanation as to why ultraviolet irradiance is utilized for water purification within this system. Through offering this information, critical assessment can be given linking the design parameters of this invention to the microbiological significance of this germicidal irradiance. Notably, the majority of this information has been drawn from those resources mentioned in detail in [0002] with heavy usage of one particular resource: Wladyslaw Kowalski's Ultraviolet Germicidal Irradiation Handbook. Though using phrasing and specifics outlined in this resource, significant time has been given to cross-referencing all stated information hereafter in accordance with other literature in the field. Furthermore, by understanding the scientific explanation behind germicidal irradiance, innovative design features encompassed within this technology can become even more clearly defined.

First and foremost, in the application of ultraviolet light, one must consider the ultraviolet light spectrum ranging from 100 nanometers (nm) to 400 nm. In particular, the germicidal region incorporates ultraviolet C wavelengths and ultraviolet B wavelengths, denoted UVC and UVB, respectively. These two regions are only half of the four regions of ultraviolet light (on occasion denoted as UV), which are defined as follows: Vacuum UV (100-200 nm), UVC (200-280 nm), UVB (280-315 nm), and UVA (315 nm-400 nm). As DNA/RNA inactivation is largely caused by the incidence of energy on the intra-molecular structure of DNA/RNA, Vacuum UV occurs at wavelengths that dissipate quickly in water. Additionally, such narrow wavelengths of light have the capacity to alter, modify, and chemically breakdown the chemical bonds found in water. This results in the development of ozone, a substance toxic to human ingestion, from the newly dissolved oxygen molecules in the water (typically forming at wavelengths less than 200 nm).

The greatest ultraviolet light quality that must be taken into account with regards to material properties is that of light propagation, or rather how light interacts with the surfaces of materials around it. In particular, light can experience absorption (light passing through a substance), refraction (light changing direction between substances), reflection (light deflected off a substance), and scattering (light diffusing away from material interaction due to particle interaction). Most important of these properties is absorbance, or more importantly, the lack thereof when designing an ultraviolet water purification system. The definition for this term can be found in [0017] however in brief, transmission focuses on how much water does pass through a media whereas absorbance focuses on how much does not. Transmission (and thus, inherently absorbance) therefore dictates the overall penetration rates by which ultraviolet light successfully permeates within an ultraviolet reactor. Due to the high absorbance of ultraviolet light in water, the design for this invention focused on minimizing the proximity of reactor walls and inspired the baffling system for the design. That said, scientific explanations regarding the passing of light through the system offers the potential for additional benefits of germicidal irradiance expressed in other light-traveling properties below. With that in mind, this patent application seeks intellectual property domain over any manipulation to the design disclosed herein that attempts to magnify or minimize the impacts of the light properties listed below in [0054] through [0057].

Absorption (A)—this property is directly proportional to the wavelength (λ) of the ultraviolet light and the material in which that light is being absorbed. Once the wavelength passes into the material, the excited energy within those photons slowly dissipates across both time and distance. As such, the wavelength becomes increasingly less and less available for usage to inactivate the DNA/RNA structure of microbial organisms. With that in mind, the innovation designed here has been designed with the intention of minimizing the radial distance between the ultraviolet light and edge of the ultraviolet reactor. Such consideration originally inspired work towards implementing a circular baffling structure as the incidence angle for ultraviolet light to any cylindrical volumetric reactor is the same at all points. Additionally, as the circularity of the ultraviolet lamp matches the circularity of the cross sectional area of a cylindrical container, the farthest germicidal irradiance distance is the direct line between the lamp and the container. This, in turn, minimizes the exposure time for the system as no corners in the reactor design offer a long absorbance time than this direct line distance. This information gives light to the need for materials used in the construction of the ultraviolet reactor to ensure that absorption of ultraviolet light is high to mitigate any harm or damage upon those manipulating this invention.

Refraction (R_{FRACT})—this property is the change in direction of the light when it propagates between interfaces of surfaces and furthermore, from one medium to another. For an ultraviolet reactor, refraction has the potential to occur at three particular locations. The first is the interface between the ultraviolet lamp and the pocket of air between the lamp and its protecting quartz sleeve. This small space will see a small amount of refraction as the refraction rate approaches one for air. The second interface takes place between this trapped air and the glass quartz sleeve. Whereas the germicidal irradiance “starting point” begins at the external edge of the ultraviolet quartz lamp, the protective quartz sleeve serves as a medium through which light must pass. As the quartz sleeve typically is only a few millimeters in thickness, light undergoes relatively little refraction here as well. With this in mind, the nature of this structure does allow for ultraviolet light to divert directions. The final interface of refraction is the protective quartz sleeve and the media fluid (in this case water) passing through the ultraviolet reactor. Recognizing that any fluid could pass through the ultraviolet collector, let it be known that embodiments of the invention relate to all fluid types desiring to be purified through the invention stated herein. With this aside, this final refraction will perceivably have the largest impact on the diversion of light sources within the ultraviolet reactor as this fluid composes the greatest cross sectional, radial distance of light travel relative to the aforementioned interfaces. Ultimately, this form of light propagation will dictate the angle that ultraviolet light exits from one medium to the next thereby dictating the incidence angle by which ultraviolet light comes into contact with pathogens and other microorganisms. Though uniformity would be found in a circular design (all angles of refraction would be parallel within a cylindrical reactor), this information directs importance to understanding how ultraviolet lighting resources permeate within a reactor and thus alters the probability of DNA/RNA inactivation within a microorganism.

Reflection (R_{FLECT})—this property is the change of light off a surface, or more specifically, how ultraviolet light changes direction by rebounding off of a material within or between mediums. Reflection can either be specular (occurs from smooth polished surfaces where the incidence angle is equal to the angle of reflection) or diffuse (occurs from rough surfaces where light scatters in all directions regardless of the incidence angle). Though this system relies purely on the use of ultraviolet germicidal irradiance, additional improvements can be considered within this property. First and foremost, reflective coatings on the inside edges and walls of the ultraviolet reactor and baffling can improve the overall irradiance within the system. In the case of using this reflective coating, additional improvements including but not limited to those agents providing small hydroxyl radicals or photochemical reactions could be utilized within this system. Secondly, in the event of improving germicidal irradiance for the design, considerations could also be given for altering the internal baffling and reactor walls to create a polygonal shape. Rather than a circular design, this shape can then reflect light down the spiral of the purification system, improving the ultraviolet dosage for germicidal irradiance. With all this in mind, this application seeks to cover this technological innovation across any modifications made to either the ultraviolet reactor structure or baffling design to maximize either the reflective qualities of ultraviolet light or aid in the utilization of any additional purification processes including but not limited to photochemical, advanced oxidation, or hydroxyl radical reactions.

Scattering (S)—this property serves as a continuation of the second type of reflective light explained in [0056] being the change of light propagation caused by interaction with a particle. This form of light propagation therefore informs one how light will continue to permeate through a UV reactor according to the interaction of that light with water particles (or in more turbid water, contaminants, pathogens, and other microorganisms). There is no guarantee by which light hitting a particle will occur in any one direction including back at the light source itself. In the case of this final scenario, back-scattering light in high enough volumes could increase the thermal heating of the lamp, resulting in fractures of the light's external quartz sleeve. In the context of light scattering through water, these molecules are larger than the photons emitted from the ultraviolet lamp. As such, they largely pass through the molecules of water with minimal scattering save for those whose interactions result in the deconstruction of water into oxygen and hydrogen atoms. As such, ultraviolet light tends to experience forward scattering, or the continuation of ultraviolet light dispersing further away from the ultraviolet lamp by radial distance. Such means that scattering follows less in accordance to the Raleigh probability distribution (equivalent to 1/λ⁴ of the photon energy). This information directs importance towards filtering the water prior to entering the ultraviolet reactor in order to minimize the number of microbes and particulates that could increase the scattering of ultraviolet light and thus, jeopardize the germicidal irradiance level of the reactor. With this in mind, this application reaffirms its embodiments cover any modification of the technology herein to include any filtration device in tandem with the water purification system.

In addition to the angle and intensity of the ultraviolet light passing through a fluid media, one must also understand the underlying way by which this light serves to inactivate pathogens and other microorganisms. At its most basic function, ultraviolet light actually damages the nucleic acid of the microbe, preventing replication of that microbe in the process of either mitosis or meiosis. By principal, the ultraviolet light therefore does not just inhibit growth by damaging cell structures or metabolic rates but also eliminates the possibility for further recontamination of pathogens on a one-by-one basis. The number of colony forming units in water samples before and after the water purification system provides a discrete measurement for assessing successful inactivation among bacteria. In contrast, this inactivation can be monitored in viruses through plaque counts in host cells and for cysts through the population of microbes in colony forming units among tissue cultures. Thus, this invention has the capacity for design modifications to support water monitoring and testing across any location within the structure of the reactor. With this under consideration, the embodiments cover any modification of the invention disclosed herein that enables increased assessment of water quality at any point within the purification process.

Expanding upon the process described in [0058], the inactivation of DNA/RNA occurs when a nucleic acid forms a dimer. This dimer is the result of two nucleic acids that are the same bonding with one another rather than its complement base pair. The two forms of nucleic acids within all pathogens and microorganisms include DNA and RNA, both of which consist of two pairs of nucleotides: purines and pyrimidines. The difference between these two nucleic acids lies solely within the pyrimidine pairs (purines in both DNA and RNA consist of adenine and guanine). For these pairs, DNA consists of thymine and cytosine base pairs whereas RNA consists of uracil and cytosine base pairs. Though structurally very similar, the chemical makeup of uracil within RNA makes the molecule much more resilient to ultraviolet light absorption. As such, this nucleic acid, on average, tends to have greater ability to thwart the ultraviolet light disinfection process and requires on average higher ultraviolet exposure doses in comparison to bacterial DNA. To obtain these higher dosages, an ultraviolet reactor must design for higher irradiance (thus requiring a greater electrical input power or modifications to the ultraviolet light itself), longer dosage time (thus requiring prolonged exposure of water to ultraviolet lighting), or greater surface area of exposure (less controllable given the nanometer sizes of these pathogens). This information uncovers that these RNA nucleic acids are typically the most difficult to remove via ultraviolet germicidal irradiance. Given such, all estimates and calculations enclosed herein are designed for the most ultraviolet-resilient RNA microorganism recorded in the literature: the Tobacco Mosaic Virus.

In terms of structural inactivation, the most prominent form of DNA compromise occurs specifically to pyrimidine dimers. Between thymine-thymine and cytosine-cytosine, the former combination tends to be the most common dimer found for DNA nucleic acids. According to experimentation, the greatest percentage absorbance by thymine occurs between 250 nm and 280 nm with a peak absorbance (approximately 50%) within the narrower wavelength of 265 nm-270 nm. As thymine absorbs more ultraviolet light than cytosine, this is typically the targeted wavelength for ultraviolet light inactivation with the most receptive target microorganisms being those with more thymine-rich DNA. In contrast, RNA pyrimidine dimers include uracil-uracil and cytosine-cytosine, neither having very high absorption rates though peak absorbance still occurs within the same wavelengths as above. For this reason, the inactivation of RNA nucleic acids typically requires a greater ultraviolet exposure dosage and thus strongly influences the success of the ultraviolet reactor. In the presence of the correct amount of ultraviolet radiation, the energy from absorbed light can break the hydrogen bonds linking these nucleic acid pairings (e.g. purine and pyrimidine structures) away from one another. In return, these pairings then form the aforementioned dimers whose bond is stronger and more stable than the previous hydrogen bond between the base pairs. With this in mind, one can see that once the proper exposure dosage has been reached and absorbed by the DNA/RNA structure, the formation of dimer structures prevents replication of the pathogen or microorganism.

In the case of DNA, the speed by which thymine dimers are formed in the presence of ultraviolet light is estimated, once reaching the ultraviolet excitation energy necessary, to be within one picosecond of exposure. The difficulty, however, is that the ultraviolet excitation must occur at the exact orientation at which the dimers are exposed. As such, the probability of this dual occurrence results in only a few percentages of thymine doublets at any one given time, contingent upon optimal conditions within the UV reactor. Similarly, the even smaller microorganisms of viruses and the RNA within these microbes pose as an even more seldom possibility for inactivation. Though little quantitative information exists on the topic, one study showed that after ten minutes of optimal ultraviolet irradiance, only nine percent of total uracil bases had formed dimers (Miller and Plageman, 1974). Despite the limited number of base pairs formed, the inactivation rate proved to achieve a six logarithmic removal of the targeted virus. This information, therefore, shows that though RNA may be much more difficult to inactivate both due to the increased stability uracil dimers and these pathogens' smaller size, the cross-linkage of dimers greatly inactivates and fully mitigates the replication of viruses. Thus, this application seeks the intellectual property domain of all modifications to the ultraviolet reactor that modifies the system design and its modular components therein (including but not limited to the ultraviolet light used in the apparatus) to improve the probability of nucleic acid inactivation in pathogen or microbial nucleic acid structures.

Beyond germicidal considerations taken in the creation/production of this technological innovation, ultraviolet irradiance and scientific calculations therein also can be utilized for the monitoring and evaluating of the system's success. Combining all of these factors together in addition to the logarithmic inactivation from tested microbial cultures, one can compose an ultraviolet dose-response relationship for the ultraviolet reactor. This curve can then depict the proportion of inactivated microorganisms to the number of remaining microorganisms within the water as a function of the ultraviolet dose penetrating into the water. As the logarithmic inactivation is strictly for one microbe, these curves can be developed for each target microbe within a reactor. Using these individual parameters, one can then overlap these dose-response curves atop each other to identify the effectiveness of a reactor in terms of removing microorganisms. In particular, if a reactor can be developed with a uniform dose-intensity, these dose-response curves can show what microbial population a consumer of the water may be more or less susceptible during optimum conditions of the ultraviolet reactor. As the dose response curve is an inherent property of the microorganism and ultraviolet light, it will not be affected by temperature, pH, ultraviolet absorbance (already considered in the dose-response curve calculations), and ultraviolet intensity (since this may fluctuate with higher energy over shorter time periods or lower energy for higher time periods).

Background—Ultraviolet Lighting Mechanisms

Before beginning a more rigorous assessment of the design parameters and considerations taken to develop the ultraviolet water purification invention disclosed, an overview of ultraviolet lamps and their specifications should be provided. Here, information on the type of ultraviolet lamp intending to be used within the operations of the ultraviolet purification tank can be described in further detail. Generally speaking, an ultraviolet lamp usually comes filled with inert gases (predominantly mercury or argon gases) and is known as amalgam lamps. Such lamps have small solid alloys placed within quartz sleeve casing that controls the vapor pressure of the inert gas filament. In the presence of electrical current, these amalgams and the inert gas within the lamp become excited, emitting a spectrum of irradiance within the ultraviolet region. In other words, the electrical energy provided to the electrodes within the lamp send an electrical current across the gas. In its excited state, this filament releases photons of a particular wavelength that incorporates the UVC light spectrum.

The primary difference in lighting apparatuses are those lamps that are low pressure (LP) and high pressure (HP), dictated by the difference of pressure and power inputs for each lamp. In low-pressure lamp models, as the name indicates, inert gas is kept at a low pressure (10 torr or 0.01 atmospheres) and requires a lower electrical power input of only 0.5 W/cm². In contrast, medium pressure lamps require a higher-pressure input of near one atmosphere (1000 torr) with higher electrical inputs. In the case of the former, the lower power constraint allows for a more stable and consistent ultraviolet spectrum. That said, the lower excitation state causes photon energy to diminish quicker after emission, with photons dissipating in energy quickly after small distances. In the case of HP lamps, the higher electrical input results in a much stronger ultraviolet irradiance (resulting in fewer lamps needed in comparison to an LP system). Though the lifetime of the photon is longer within surrounding media, the spectrum itself is far broader reaching within and outside of the UVC spectrum, ideal for optimizing the germicidal dosage on a wider variety of microbes.

In either system, efficiency of the conversion between electrical energy and ultraviolet light creation comes from the particular type of cathode utilized. In practice, there are two types of cathodes standardly used in germicidal irradiance: the cold cathode and the hot cathode configurations. In the case of cold cathodes, ultraviolet lamps require a small amount of input electrical energy. By functioning off of lower electrical energy inputs, this cathode typically requires the fluctuation of starting voltage for the system to build the lamp to full operating capacity. This gradual growth in energy causes the lifetime of the lamp to not be tampered. That said, the voltage drop across the electrode must remain rather high, increasing the amount of input energy necessary to maintain this system. In contrast, a hot cathode based on coiled tungsten filament tends to accelerate the depreciation of the lamp's lifetime, stripping away the tungsten and its protective coating for quick replacement. While the electrical efficiency of the system may be higher than the cold cathode (with higher operating temperatures consistent to that of the mercury filament itself), this system requires a longer runtime to allow for maximum use. As such, the lamp is better for long duration application with concentrated water disinfection, starting very quickly but doing so at the expense of the electrical integrity of the lamp. On average, LP lamps tend to have an operating life of 10,000-16,000 operational hours whereas MP lamps tend to have an operating life of 8,000-10,000 operational hours.

Additionally, both LP and MP lamps are similar in the ways at which lamp starting can occur, predominantly dictated by the ways that voltage is applied and maintained between the two electrodes. In order for a system to function properly, a high voltage must be developed to initiate ionization across the lamp which is then maintained for the entire system. To achieve this voltage, lamps are designed in one of three ways: preheated, instant-start, or rapid-start. Preheated lamps use low levels of voltage to slowly stimulate the electrodes and ionize gas. Once adequately preheated and the gas ionized, the preheating starter turns off and the voltage differential across the cathodes maintains the ionization of the inert gas. In the instant-start system, ballasts are required to transfer very high voltage densities (400-1000V) into the appropriate current densities, ejecting electrons between the electrodes and through the gas that instantly ionizes it in passing. The final alternative, the rapid-start system, achieves the same necessary voltage as the instant-start system just does so through varying the resistance within the ballast. As this is more easily controlled under the same voltage conditions as the preheating system, rapid-start systems are very inexpensive, require less input energy, and have lower power losses while still achieving an extremely short starting time (1 second). Based on the information provided regarding these lamp mechanisms, this patent application seeks intellectual property rights over all lamp types and ballast variations integrated for this technological innovation.

A second attribute of ballasts beyond function also pertains to the material developed for the ballast. This material typically differs between electronic or magnetic ballasts. At present, the most efficient system uses electronic ballasts. Alternatively, magnetic ballasts (functioning through some properties of magnetism and magnetic flux to regulate voltage and current flows) have been proven to be inefficient. Taking the ballast factor and multiplying it by the input power supply creates an efficiency rating for the system as a whole, dictating the overall efficiency of the ballast. While magnetic ballasts are unreliable due to magnetic properties, electronic ballasts can fluctuate in efficiency ratings away from those projections by rapid fluctuations in temperature. Electronic ballasts have the ability to be started instantly caused by the usage of soft-iron thimbles whose electron state can become excited easily. This benefit allows for rapid starting and stopping of the lamp without affecting lamp life (ideal in the case of developing a system where flow rates are dictated by the usage of customers).

Having explained the basic components of the electrical wiring and regulations of the power supplied to the system, further explanation can be provided for the various lamp types. At present, three distinctions can be found for the types of lamps used including low-pressure mercury lamps, high-pressure mercury lamps, and light emitting diodes (LEDs). The most prominent technologies, LP and MP lamps, have been regularly implemented in most competitive products on the market. In contrast, LEDs are becoming further tested with the hope of implementing this light type in the foreseeable future. The basic components of both mercury lamp types include a pair of electrodes, a quartz glass casing, and mercury amalgam. In essence, the two electrodes on either side of the casing create an electrical current that, when run through the inert gases, establishes superheated plasma. At these temperatures, the excited mercury releases an ultraviolet wavelength within the desired spectrum, releasing photons that effectively inactivate the target microbes. Electronic ballasts are used to moderate the resistance of electrical energy into the system, providing the proper electrical current across the electrodes. In other words, the ballast is designed to alter the voltage of power coming from an electrical source with varying resistances to ensure constant current running between the electrodes. The consistency of this current is vital for the effectiveness of the system as it is this stable current that controls the superheating of mercury amalgam and monitoring of ultraviolet emissions. The glass type chosen for most mercury-based lamps is quartz as this material is highly transparent to ultraviolet wavelengths and allows for high transmission into the disinfecting material. Explanations of each technology are provided below in [0069] through [0071].

As the above information supports, the most critical component of the LP lamp is maintaining the pressure of mercury within the system. As the amalgam superheats, pressure increases within the quartz casing, ultimately enabling the desired wavelength to be emitted. If this pressure were to drop, more energy would be necessary in order to maintain the minimum pressure needed, thereby requiring more power. However, as the ballast regulates the current within the system, a loss of pressure irrespective of the electrodes would become a persistent defect within the system at large. As temperature and pressure have a direct proportionality, any drops in temperature contributes to a decrease in pressure throughout the system. With that in mind, it is important that the ultraviolet reactor have the ability to maintain stable thermal properties and well-insulated heat retention within the reactor. LP lamps typically see 60% efficiency for electrical energy into excited ultraviolet light of which 85% of this light produces 254 nm wavelength UVC. Though not within the 260 nm-275 nm wavelength band of maximum thymine or uracil absorption, mercury emits photons at a wavelength of 254 nm naturally and thus offers the closest possible alternative. Further convective losses from this system create lower overall efficiencies on the order of approximately 30%. With this in mind, this application takes intellectual property domain over all adaptations made to this system to prevent convective losses for maximum ultraviolet light efficiency.

By comparison, the LP lamp also operates on a much lower scale across the board in comparison to the MP lamp. Low-pressure mercury lamps tend to operate at a temperature of only 40 degrees Celsius with a very small pressure required, producing a monochromatic wavelength of ultraviolet light at approximately 254 nm. In contrast, an MP light operates at a much higher pressure (approaching one atmosphere) with an operating temperature of 600-900 degrees Celsius. This system typically causes mercury atoms to collide with one another, resulting in an exothermic heat release to the surrounding environment. With these more unstable reactions, the mercury wavelength becomes scattered, releasing photons at different energy levels. This in turn creates a broader ultraviolet spectrum with light tending to range anywhere between the mid-300s nm to dropping as low as 185 nm. At this lower wavelength, excited photons can lead to the decomposition of water molecules, ultimately inciting the creation of ozone gas. Whereas the residual release of ozone in LP lamps may be on the order of only a few percent of the total photons emitted, MP lamps often must be regulated or only utilized for large volume reactors where the dissipation of photons will prevent ozone from being ingested.

At the time of filing this application, ultraviolet lighting resources has been explored via the use of LED bulbs and point-charge strands. Recognizing that this is the direction of the field, we wish to bring forth this lighting mechanism to introduce and protect potential future lighting applications and manipulations that may occur using this system. Among the greatest attributes of ultraviolet LED systems is their ability for rapid starting/stopping as well as their lack of electronic ballasts to operate. Using the p-n junction and properties of photovoltaic cells, passing electrons through materials of varying electrical charges creates ultraviolet irradiance. Together, these structures can provide a reliable ultraviolet wavelength that emits radiation as a solitary point charge. While the system does not require the use of toxic mercury amalgam, the development of hybrid alloys and doped metals results in the harvesting of many rare earth metals for their unique electromagnetic properties. In addition, most existing systems have only utilized LEDs for very small water samples with very small power supplies ranging across very small radial distances. As such, the technology has not had the ability to be utilized for large volume applications and remains insufficient for the usage with the invention disclosed herein. That said, this technology proves most worthwhile to be followed moving forward, especially given its capacity to optimally target microbes at the wavelength of 265 nm. Once acquiring higher efficiencies and diameters of irradiance, such a technology can and will be utilized within this invention's design. Recognizing this, the embodiments cover the usage of any ultraviolet LED lighting source as a means of producing germicidal irradiance within this water purification system.

Areas of Design Considerations

Although the following considerations neither fall under the category of germicidal irradiance nor the components inherent to lighting mechanisms producing germicidal irradiance, they were nonetheless considerations that significantly altered the design of this invention. With that in mind, this patent application wishes to formally display the parameters that significantly guided the creation of this invention. At the same time, we intend to establish intellectual property on the functional, operational, and conceptual considerations resulting as a byproduct of these considerations. In the sections that follow, some design considerations will be consumer-based ([0073] through [0075]), others will be biologically-based ([0076] through [0082]), and the remaining will discuss future considerations for design modifications and iterations moving forward ([0083] through [0085]).

Efficiency Functions Via Waiting Time—In the process of creating this system, due consideration was given to those customers receiving the purified water. Ultimately, though attempting to protect this technological innovation, greater focus has been devoted to serving a community with this product. For any purification system attempting to provide a scarce resource like water, technological designs must attempt to minimize the time and energy needed to provide the resource. In the case of water disinfection, even further consideration must be taken due to the compounded waiting time of individuals all requiring this scarce resource. For example, imagine twenty individuals standing in line waiting for water from a purification reactor. While the process itself may only take two minutes to purify enough water to fill a mobile container for one person, this would result in 40 minutes of waiting time for the twentieth person in line at the very least. In the absence of efficient purification, individuals may seek alternative water resources simply due to convenience, regardless of the cleanliness of the water. As such, this technological innovation was designed to cater towards the last person in line rather than the first. By focusing on the long-term productivity and efficiency of personal water collection, this system design altered to become small in scale, flow-of-water in treatment, and pushed to minimize exposure time as much as possible. This explains the reason for designing a system that maximizes ultraviolet exposure dosage in a matter of seconds, not minutes, for holistic water purification that can supply to an entire community, not only to an individual.

Utilization of Previous Infrastructure—Similar to the considerations for the consumer with regards to the waiting time of consumers, the design of this invention also adapted to take into account modern-day infrastructure. In many fields of implementation, resources will be limited for public health and wellbeing (otherwise, the installation of such a purification system would be largely irrelevant). When tackling the water crisis, therefore, alterations could either be made at the source or around the source of the problem. Much of the reason water becomes contaminated is that the storing or dispersing conditions by which water rests or travels in, respectively, contaminates the water. With the inability to create such a systematically wide change, our device focused redefined the problem from one of source-based contamination to one centered on consumption of contaminated water. Focusing on this second issue area, this design takes advantage of the public utilities available in cities, towns, and public works. Through these systems, water can be transported from any source location and dispersed across any distance to reach the final consumer location. Only after acquiring the maximum possible contamination can the research problem of this technological innovation then become relevant: point-of-exit purification. For this reason, embodiments disclosed herein cover the point-of-exit use of this purification system as well as any installation of this invention across any public works water transportation pathway. For the record, while prioritizing point-of-exit purification, this design can also be (more-easily) implemented for source waters as well and this application should be considered covered by embodiments of the invention.

Point-of-Exit vs. Point-of-Entry—In addition to these system components, the ultraviolet reactor design must also take into consideration the fluid dynamics of influent waters throughout the system. Depending on design parameters, flow rates may modify to cause insufficient exposure to ultraviolet radiation, especially if the system creates very turbulent flow patterns. Such flow patterns would be found in the case of point-of-entry decontamination whereby germicidal irradiance was only focused on a hyper-localized specification of the invention. In the case of turbulent water flow, water tends to spiral or circle into different locations within the reactor, often settling within the reactor for long periods of time. In these dead zones, water can either completely avoid being hit by any irradiation, escaping the ultraviolet reactor untouched, or become overly disinfected, preventing the proper irradiation levels for other waters in the reactor. In high volume apparatuses, dead zones serve as inefficiencies as disinfection is distributed across the entire volume of the reactor. For small-scale devices, turbulent water flow inhibits proper attainment at influent water's point of entry. In contrast, more laminar flow can effectively cause linear water circulation patterns that allows for more accurate and easier calculations of ultraviolet dosage. For laminar flow, water moves relatively uniform throughout a system, which can be monitored using baffles and other flow control devices. This homogenous flow pattern allows for more specific microbial inactivation, preventing the turbidity of water from reducing inactivation levels while at the same time increasing the movement of microbes in water to maximize the probability of microbial inactivation. With this in mind, this invention pushes for more point-of-exit disinfection whereby laminar flow can become disinfected more easily. This application covers any attempts to maximize the amount of laminar flow within this system and reduce turbidity for optimal purification.

Photo-Reactivation—This process, also called photo-repair, occurs when enzymes within bacteria use UVA and visible light to break the covalent bonds formed between pyrimidine dimers (wavelengths typically 310 nm to 490 nm). This exposure predominantly occurs within bacteria that actively have the enzyme in their own cell structures. In contrast, RNA structures of viruses typically activate this repair only through using the enzymes of host cells rather than ambient light. As one may guess, the higher the irradiance and ultraviolet exposure dosage experienced by the cell, the more inhibited the bacteria is from reproduction. With this in mind, an ultraviolet reactor design must take into consideration the rate at which water is disinfected. Additionally, such a design must consider the exposure time that water will have to sunlight after the purification process via the ultraviolet reactor and the properties of the water storage tanks within which disinfected water will be housed. Such a fear for photo-repair further emphasizes the need for higher ultraviolet dosage, typically above 40 mJ/cm², in an effort to minimize the onset of this enzyme's activation. Alternatively, purified water should try to be stored in dark conditions for at least two hours after disinfection. Taking this concern into consideration, this application covers all modifications to this system to minimize the onset of photo-repair including but not limited to the use of chemical additives, the opaqueness or light rejection within the ultraviolet reactor, or modifications made to maximize the exposure dosage to prevent photo-repair.

Dark Repair—In contrast to photo-repair, dark repair (which has no bearing on the amount of sunlight needed) is an enzyme-induced process whereby DNA or RNA is repaired within the cell. This process typically works through excision: the removal of the pyrimidine dimer and replacement using another strand of the same DNA or RNA. This occurs most frequently for microorganisms with double stranded DNA and RNA as the excision of one replicated strand can be used for a dimer in the counterpart strand. However, in the case of single strand DNA or RNA, the microbe must rely on the excision of the new nucleic acid strand from a host cell. In most cases, microorganisms lack the ability to undergo dark repair unless having a host cell thus emphasizing the importance of adequate ultraviolet disinfection within the ultraviolet reactor. In the absence of adequate purification, this form of re-activation by pathogens of microbes can occur within the tissues of the individuals drinking the water. For all testing purposes, ultraviolet doses and ultraviolet dose distributions take into account the possibility of dark repair unless otherwise specified in the literature. Taking this concern into consideration, this application covers all modifications to this system to minimize the onset of dark repair.

Ozone Creation—One strong concern in the introduction of ultraviolet irradiance is the creation of ozone, a photochemical byproduct that arises from high-energy flux through water. In this process, the disassociation of water molecules within water promotes ozone creation that becomes a dissolved compound within the water itself. Though an oxygen-based compound, the accumulation of this substance over time results in increased toxicity to humans. With that in mind, it is important to design an ultraviolet reactor that minimizes the possibility of creating photochemical byproducts, specifically that of ozone. This development typically happens at ultraviolet radiation levels at the lower end of the UVC spectra, namely at wavelengths below 200 nm. With that in mind, it comes as no surprise why LP lamps have very small creation of ozone, approximately 0.3-0.4% by weight of the mass of water per liter of volume. With 98% of the irradiance from LP lamps concentrated around 254 nm, this percentage drops to such small percentages that it falls beneath the 0.1 ppm by volume requirement within UV disinfection tanks. That said, the likelihood of ozone toxicity is higher for the polychromatic spectrum of MP lamps where mercury gas consistently exudes 180 nm UVC. It should be noted that even in the event of ozone creation, these molecules quickly disassociate in water to become oxygen gas after a 15-20 minute time interval.

Pathogen Resilience Standards—When considering the different means of purifying water, pathogen resilience standards need to be made for the worst possible scenario. In this way, this purification system can take into account not only those pathogens that are known about at present but also many of those that are not known yet. In this manner, preparations can be taken to ensure protection for all purposes and concepts after the end-of-life of the purification reactor. To provide these sufficient calculations, all pathogen resilience standards are based off of the Tobacco Mosaic Virus. This single strand RNA molecule is extremely resilient to ultraviolet irradiance by nature. Also its smaller size minimizes the surface area by which germicidal irradiance can hit the pathogen. With a robust microbiological replication process, the pathogen is also very capable of undergoing photo-repair or dark repair even after purification. With this in mind, the ultraviolet exposure dosage takes into account the intensity of an exposure dosage needed to mitigate the activation of the replication enzyme. All calculations inferred hereafter used a minimum exposure dosage of 733,333 micro-Joules per square centimeter for the exposure dosage. This application, therefore, covers any modifications made to this system that provide the minimum ultraviolet exposure dosage for any pathogen of more rigorous standards than that which has been found to date.

Health Safety Considerations—As with any technological innovation, considerations must be taken to protect against equipment failures or malfunctions, particularly with system components including electricity. In the case of the ultraviolet lamp, system malfunctions or follies can result in human exposure to ultraviolet light and can be caused by any inconsistencies in terms of power supplied to the lamp or electrical wiring. Most particularly, direct immersion of ultraviolet lighting sources within water or other fluids can result in extremely drastic side effects both in terms of electricity in the presence of water or mercury toxin exposure. In the case of water hitting an electrode, the system has the capacity to explode, damaging the ultraviolet reactor and injuring all those operating the machinery. In the case of a fissure in the ultraviolet lamp, release of mercury amalgam or other inert gases can lead to lethal toxicity to water consumers. Regardless of these design structures, the most important component of construction must be protective sealing and encasement of the ultraviolet light source. If improperly managed, the UVC spectrum can cause serious damage to the skin and eyes, most particularly to the latter given the inability for cell reconstruction. Ultraviolet light within this wavelength impacts the cornea as this absorbed light can result in photokeratitis or keratoconjunctivitis with inflammation of the eye itself In this case, the epithelial layer of the eye becomes damaged, taking 4-12 hours for visual recuperation though sometimes as long as 48 hours or temporary blindness. With this in mind, it is extremely pertinent that all ultraviolet reactors have safe, emergency power kill switches to prevent blinding in the event of system failure. This application therefore covers any modifications made to this system that protect operational staff, maintenance staff, or other individuals manipulating or seeking water from exposure to ultraviolet light, mercury leaks, or any malfunction of the system.

U-Tube Safety Parameters—Along the lines of health safety conditions as noted above in [0080], the use of ultraviolet lamps in the shape of a “U” have been discouraged, though not rejected outright, from being utilized within this system. When originally developing prototypes of this invention, the lamp mechanism used included this traditional “U” shape. However, in the process of creating these fixtures, quartz must be superheated, bent into shape, and then rapidly cooled, often via air injections. Given the rigor, speed, and accuracy of this process, very few ultraviolet lamps of this shape can be protected by a secondary quartz sleeve. With this in mind, the usage of this lamp would predominantly require the direct exposure of that lamp to influent water flow. Such exposure poses dangers for leaking of water into the quartz lamp with exposure to electrodes leading to drastic system malfunctions as noted in [0080]. Additionally, the use of a single-sleeved “U” lamp would also allow water within the reactor to have a significant impact on the ambient temperature during lamp operations. As the process of ultraviolet irradiance is temperature dependent, influent water into this technological invention could cause inefficiencies in the electrical energy acquired. Such electrical losses then increase the inefficiency of the system's operations as well as compromise the integrity of the ultraviolet lamp and quartz sleeve at large. Given Henry's Law and the relationship between temperature and pressure, fluctuations of water temperature within the ultraviolet reactor could also increase or decrease the pressure of mercury gas within the amalgam lamps. If this is the case, then pressure could drop to a point where no germicidal irradiance is produced or increased to the point that the lamp implodes. This application therefore covers any modifications made to this system that protect operational staff, maintenance staff, other individuals manipulating the reactor or the integrity, functionality, and operability of this invention in accordance with mediating and regulating the temperature of influent water.

RPT Safety Parameters—Recognizing the concerns raised in [0081], this invention tends to utilize a manufactured product, patented under U.S. Pat. No. 7,569,981 B1, that was created by Light Source Incorporated. The company first offered this technology in the prototyping phase of this invention and helped discuss competitive commercial advantages from a ultraviolet light mechanism perspective for the continuous, helical baffling system. Before consultation, this baffling system was juxtaposed with a system design centered upon the circulation of ultraviolet lighting mechanisms around a central column of water flow. However, given the ingenious socket and base design for the ultraviolet light, this lighting technique can offer tremendous benefits in terms of creating an easily-installed, simplistic ultraviolet light scheme. With the fastening capacity of the socket and base design, the RPT lamping mechanism can help secure ultraviolet lights in both the bottom and top of the baffled screw. Such security allows for a much wider feasibility of connecting electrical wiring and circuitry to the system, maximizes the system's installment flexibility across various applications and verticals. Additionally, the purple-emitted light from the heel of this lamp allows for safe operation of the lighting mechanism, minimizing the probability of photokeratitis or keratoconjunctivitis, both of which have been discussed in [0080]. Though this patented lighting source has received its own patented protection, this application seeks intellectual property domain over any modification made to the baffling device, container, or any part disclosed herein that attempts to offer similar security and ease of operation for the ultraviolet lighting source as that identified in patent US 7569981 B1.

Addendum Filter Usage—As noted in [0044], water purification centers upon both the decontamination and disinfection of water resources. While this system ensures that water has been disinfected with the inactivation of pathogens and microorganisms, decontamination lies outside of the inherent functionality of this ultraviolet disinfection reactor. That said, an addendum filter is critical to ensuring the full-scale removal of particulates and other contaminants. Irrespective of shape, size, media filament, and residence time, an addendum filter should be used in combination with this ultraviolet reactor. Ideally, this filter will remove particulates to the smallest diameter possible including but not limited to the use of sand, pebbles, activated carbon, micron, or reverse osmosis filter applications. The removal of these contaminants should ideally be to the smallest extent possible without compromising the integrity or need for the disclosed ultraviolet disinfection system. While contaminants and particulates should be removed to meet purification standards, they are also imperative to decrease the turbidity of water flowing through the system. Lowering the turbidity through this filter will maximize the efficiency by which the ultraviolet reactor can inactivate pathogens and other microorganisms. That said, the connection between the filter and ultraviolet reactor must be one that does not allow filtration media from entering into the reactor and imposing issues with turbidity along those lines. Taking this into consideration, this patent application covers all embodiments that attempt to modify the system or connections between filter and disinfection reactor for the purpose of reducing, removing, or preventing the flow of particulate matter. Additionally, this patent application takes covers all modifications to the invention herein to reduce the turbidity level of water in order to improve the exposure dosage of ultraviolet irradiance.

Photochemical Reactions—any use of ultraviolet light induces a photochemical reaction described above in [0025] and furthermore in the figures following and explanation provided in [0035]. These reactions occur when energy from various photon emissions have the excited energy to manipulate the nucleic acids in DNA and RNA. With this in mind, the amount of ultraviolet light made possible for utilization within this system is desired to be optimized to the best of the design's ability. At present, no considerations have been taken for increasing the photochemical reactions within this system beyond the use of ultraviolet light. However, the implementation of titanium oxide as a photocatalyst to increase the potential for the creation of hydroxyl radicals and to further increase the efficiency of photochemical reactions has been considered. Though not limiting this intellectual property domain solely to the coating of titanium oxide, the hydrophilic properties of the chemical make it extremely attractive as an inner lining coating to any ultraviolet reactor. With this in mind, this application covers any manipulation made to this ultraviolet reactor to increase the photochemical reactivity within this invention.

Oxidation Radicals—outside of increasing the photocatalytic reactivity within the ultraviolet reactor, additional benefits can come from the disinfection of water through the process of oxidation. Commonly found in the treatment of wastewater, these chemicals are utilized for the removal of organic and inorganic materials. This process primarily occurs via the use of hydroxyl radicals including but not limited to the use of small amounts of ozone, free chlorine, or hydrogen peroxide. These hydroxyl radicals are most important for the removal of free oxygen within a water source, lowering the chemical and biological oxygen demands within influent water. As this dissolved oxygen acts as a potential promoter of biological activity and growth of pathogens and other microorganisms alike, this dissolved oxygen is ideally removed through oxidation-reduction reactions. Whereas titanium oxide serves as a chemical coating and catalyst for these reactors, other chemical agents including but not limited to free chlorine, hydrogen peroxide, or ozone can be added to an ultraviolet reactor using some type of injection method. Taking this into consideration, this application covers any modification made to this system to allow for a chemical additive or interval chemical injection. Additionally, this application covers any modifications made to this system that enable increased oxidation or hydroxyl radicals to be created within influent waters into or upon the surfaces of the ultraviolet reactor described in this patent application.

Previous Works/Design Considerations

Before proceeding into the description of the technology herein, explanations of previous technological designs will also be provided and explained. As the full-scale prototyping of this design occurred over several months, many previous iterations of devices also paralleled the patented function described herein. To limit the amount of competitive advantage for the patented design and to cover potential future modification of the technology in future iterations of the design prototyping, the descriptions of previous works hopes to solidify intellectual security over plausible apparatuses that offer similar purification benefits. By providing this step-by-step approach, alternative adaptations or expansions for this design can also be included within the overarching provisional patent filed. Moving forward, these adaptations can then be filed in conglomeration with one another at the time of this application's priority date in the foreseeable future. All previous works are described in [0087] through [0103].

CSTR—Completely Stirred Batch Reactor—The primary factor contemplated in the original creation of this ultraviolet purification system was the utilization of CSTR or PFR water flow profiles. In the case of a completely stirred reactor, the ultraviolet exposure dosage is dependent upon the average volumetric ultraviolet intensity within the system. That means to say that the ultraviolet exposure dose is based on the average intensity of germicidal irradiance felt on a microbe farthest from the ultraviolet light. In other words, the average ultraviolet exposure dosage is based on the average exposure felt on the pathogen or microorganism retained for the average residence time within the reactor. As all contaminants and microbes within the reactor become completely stirred throughout the volume of the reactor upon entrance, disinfection does not occur evenly on all influent water. Taking this into consideration, one can see that the disinfection rate of a CSTR designed system is contingent less on the efficiency of the germicidal irradiance entering into the reactor and instead the average retention time of microbes within the reactor. Recognizing this, modifications were made to this technological innovation to prevent purification dependence from being on any factor except the germicidal irradiance and exposure time of water to ultraviolet light. That said, this patent application covers any manipulation or modification of this technology for the implementation or application within a CSTR water purification reactor.

PFR—Plug Flow Reactor—Recognizing the inefficiencies coming with a completely mixed reactor, design modifications were made to focus on a traditional plug flow reactor instead. Whereas the completely mixed reactor assumes perfect mixture across the entire volume of the reactor, a PFR instead is comprised of continuous “plugs”. As water moves in continuous, uniform compositions along an axial direction, each cross sectional plug functions independently from those around it. As such, ultraviolet purification through ultraviolet light can be maximized within each of the plugs throughout the entire flow through the system. Under these parameters, variations in exposure dosage will differ according to the radial distance of the ultraviolet light to the inner walls of the ultraviolet reactor. As such, the smallest exposure dosage will be felt along the inner edges of the ultraviolet reactor, thus projecting the longest possible exposure time for the reactor. At the same time, the plug-flow reactor must consider the impact that flow rate has within the system and develop a dose distribution that takes into consideration the fastest fluid flow throughout the entire system. Thus, the ultraviolet exposure dose must be designed to conservatively eliminate microorganisms farthest from the ultraviolet lamp across the shortest residence time. That said, this patent application declares full intellectual property domain on any manipulation or modification of this technology for the implementation or application within a PFR water purification reactor.

Central Casing Design—The first iteration in the process of creating this invention constructed on one central casing for optimizing the flood capacity of an ultraviolet reactor. This device established one central cylinder housing ultraviolet light sources including but not limited to six ultraviolet lights housed in one larger quartz protective sleeve. Each of these lights would contain a blinder, shading light from being emitted backwards against other lights within this central pocket. This accommodation was made in order to prevent the overheating of the central column wherein the ultraviolet lights were stored. By having each of these lights project ultraviolet light across a 180 degree radius, no ultraviolet light from one light had the capacity to increase the internal pressure or temperature of any other lights. Recognizing the increased size of this internal ultraviolet chamber, the overall water available within this reactor would decrease unless the radius of said reactor was large. To determine the overall volume of water possibly stored within this reactor type, the volume of water within the overall reactor walls would have to be subtracted from the overall volume of the ultraviolet reactor chamber.

When designing this system, various benefits and consequences arose dictating the need for alternative designs. On a positive note, this design allows for one central column to house ultraviolet lamps allowing for easier maintenance and repairing. With restricting angles for each of the ultraviolet lamps, prevention of overheating can allow for more optimal performance. As the range of incidence for each ultraviolet lamp spectra overlaps with those surrounding it, the ultraviolet dosage from the lamps magnified the exposure dosage within the reactor. Additionally, since all ultraviolet lights are housed within a central ultraviolet light chamber, the cleaning of protective casing can ensure continued ultraviolet irradiance intensity without having to clean individually soiled lamps. Along those lines, lamps within this system can be taken on and offline for replacement, repair, or other maintenancing without necessarily preventing the running of the system.

With all this said, the negative consequences arising from this system proved to outweigh the benefits for the ultraviolet purification application desired. Though water passed through the system, the plug flow reactor design caused for one straight axial flow pattern, minimizing the change of direction of water flow. As such, the probability for intermolecular collisions and optimum exposure of microbial nucleic acids to ultraviolet light was minimal. Recognizing this, the failure of this system offered insight into the need for some type of water baffling without increasing the turbidity of the water flow via a turbulent flow trajectory. Additionally, this system provided insight regarding the importance of scale for the system, especially given the width of radial distance for the reactor required to ensure adequate volumetric purification. In the absence of a narrow radial structure, this reactor design faced decreased irradiance and minimal power efficiency. Taking these design flaws into consideration, this system helped deter efforts towards a more energy-conserving design that maximized the radial usage of the reactor. With this said, this patent application covers the apparatus described in [0089] through [0091] and all modifications made to this invention regarding the information disclosed within these listed paragraphs.

Dispersed Reactor Design—The second design option considered for implementation also followed a plug flow reactor but attempted to capitalize on diversified ultraviolet light placement. In doing so, this ultraviolet reactor would maximize the exposure dosage possible across the entire reactor. With lights dispersed across the reactor, irradiance can be maximized across all cross-sectional locations within the reactor. This design included but was not limited to a few central lights within the center of the reactor with a few lights surrounding the edges of said reactor. Here, as the ultraviolet lamps would each be protected by their own protective quartz sleeves, the volume of water within the reactor would consist of the reactor volume less the volume of each individual ultraviolet chamber. Though the flow profile of water is not entirely circular, all influent water does follow the same axial trajectory without any change of axial direction. As such, similar issues as those found in the previous design iteration discussed in [0091] can be found regarding the minimized potential for intermolecular collisions and orientation differences for nucleic acid inactivation.

When designing this system, various benefits and consequences arose dictating the need for alternative designs. On a positive note, this reactor has the capacity to increase the ultraviolet irradiance across the surface area of the water. Without restricting shields needed to reduce the thermal inductance of surrounding ultraviolet lamps, ultraviolet irradiance can circulate more holistically across the water flowing through the reactor. Additionally, without one central chamber for housing ultraviolet lamps, more water can flow through this design in comparison to that previously noted. As such, the reactor wall radius can in fact increase without minimizing the irradiance of the system as long as the space of lamps ensures a minimum desired ultraviolet exposure dosage to each cross sectional location within the reactor. As with the previously stated design noted in [0090], this system has modularity in the overall functionality of the system with lights having the ability to be taken offline for repairing, replacing, or maintenancing without jeopardizing the underlying integrity of the purification process.

With all this said, the negative consequences arising from this system proved to outweigh the benefits for the ultraviolet purification application desired. As this design includes a large number of ultraviolet lamps, the power demand for this system also similarly increases. As such, so too do the expenses and complexity of the system as more circuitry, electrical wiring, ballasts, and micro-controllers for the system are also required. Depending on the alignment of lamps within the system and any movement taken by these lamps, disproportionate disinfection profiles can appear resulting in too much disinfection in some areas and dead zones in others. With regards to the sustainability of purification techniques, this design's increased energy input also may infringe on the total off-the-grid applicability of such a design. As such, the increased wiring, increased power, and less available power resources would accrue large operating costs, maintenance fees, and manipulation, lowering the net utility of such a system. Still further, the disbursement of ultraviolet lamps throughout the reactor also left some close to the reactor walls, decreasing the efficiency of these lamps as much of the irradiance was immediately absorbed by the reactor walls. With this said, this patent application covers the apparatus described in [0092] through [0094] and all modifications made to this invention regarding the information disclosed within these listed paragraphs.

Modular Unit Design—recognizing that the previous options all focused on full-scale reactors, this design focused instead on an adaptation towards more modular, small-scale devices. Though desiring to disinfect a large volume of contaminated water, this could just as effectively be done in many parts rather than done all at once. As such, the introduction of modularity became most pertinent through this design and pushed towards creating one easily-manufactured and replicated design for circulation of smaller volumes of water. Unlike those systems presented in [0089] through [0094], this more modular unit could maximize the germicidal irradiance of the system for the radial direction of light flux within the reactor's cylindrical column. This means to say that the ultraviolet light could more easily transmit through water within the reactor given the radial distance between the light and reactor wall could be much smaller in distance. Recognizing this new advantage, such a design needed to have as large a disinfection for the least cost and energy input as all unit costs and energy would be magnified for each new module introduced into a larger purification system. Additionally, the problem of radial distances became redefined to now be a tradeoff between volume and exposure dosage. For smaller radial distances, purification would be certain but for much smaller quantities of water and thus resulting in more modules needed. For larger radial distances, the volume of water disinfected would be of much higher quantity but of potentially lower quantity depending on the exposure dosage at the farthest radial distance of the reactor. This tradeoff introduced the need for considering exposure dosage and exposure time simultaneously in the pursuit of the most optimal ultraviolet water purification reactor.

When designing this system, various benefits and consequences arose dictating the need for alternative designs. On a positive note, the design for such a system was rather straightforward: one ultraviolet lamp with a protective quartz sleeve lying in the center of a cylindrical container whereby water passed around the protective casing of the lamp. Such a design offered the most flexibility and adaptability any commercial vertical. Continuing upon this, such a design allowed for easier maintenance and repair of any one module while another module was taken offline. By having numerous modules in operation at any one time, the functionality of the system could easily be maintained using one fewer device than before. As such, the purification of water would remain continuous, even if at smaller volumetric capacity, at any given time within a community, household, or operating facility.

With all this said, the negative consequences arising from this system proved to outweigh the benefits for the ultraviolet purification application desired. Given the singularity for each lamp to each reactor, no cleaning could occur that would prevent one entire module from being taken offline. Additionally, with the need for numerous modules in order to ensure the desired volumetric payload of purified water, the entire system (even if each module itself required less) demanded more energy on the whole than one centralized disinfection tank. Along these lines, the usage of centralized disinfection limited the electrical circuiting and wiring necessary for system operations. With greater difficulty in coordinating these electrical wiring demands, a full-scale electrical circuiting could be difficult to navigate without experienced electrical engineering. Additionally, given all the housing necessary for these circuits and respective devices, sufficient infrastructure will be needed to ensure the support of electrical machinery for sustained system functioning. Finally, as these systems would most likely be placed in tandem and run off separate modules, increased points-of-entry are created for potential contamination. In other words, given the complexity of numerous modules, pathogens and other microorganisms have the potential to enter into this system and support recontamination of influent water resources. With this said, this patent application covers the apparatus described in [0095] through [0097] and all modifications made to this invention regarding the information disclosed within these listed paragraphs.

Concentric Circling Design—despite the negative consequences arising from the development of this more modular design, we recognized that tackling water purification through a subdivision of overall water volume proved more optimal than one large disinfection container.

This next iteration of the design therefore adapted in order to try and maximize the irradiance within each smaller module. At the same time, this design attempts to increase the size of the modules themselves in order to minimize the separate ultraviolet reactors necessary to purify a large volume of water. For this design, water flows in one concentric circle, passing around until reaching one location. In contrast to the axial flow of previous designs, this system focuses on creating an axial flow parallel to the ground: water revolves in concentric circles until reaching the central exit point. Here, water would then flow perpendicular to the axial flow out of the system. Such a design maximized the amount of vertical space within the reactor as well as increased the overall surface area by which water was exposed to ultraviolet germicidal irradiance. Through a cross sectional analysis, the water essentially moved through one elongated rectangle with the total volume of the reactor being this rectangle less the individual volumes of each ultraviolet lamp within the reactor.

When designing this system, various benefits and consequences arose dictating the need for alternative designs. On a positive note, this system had the ability to maximize the surface area by which water was exposed to ultraviolet irradiance. Utilizing LED point charges or very small ultraviolet lamps spaced across intervals within the concentric circle, the exposure dosage per cross sectional area was the largest of any other preliminary design. Additionally, the concentric circle did not require a great deal of overall volume in order to offer a long enough exposure time for pathogen or other microorganism inactivation. While water flowed through the system parallel to the influent flow profile, effluent water flow was perpendicular to this. Such a design allowed for the increased possibility of implementing this purification system for multi-directional water flow. As the concentric circle composition allowed for water to flow in a natural coiling motion, no baffling system was needed to increase the probability of adequate exposure for disinfection. Adding to this, the concentric circle structure minimized the total cross sectional area for which water was needed to flow, decreasing the thickness of the walls between circles within the reactor.

With all this said, the negative consequences arising from this system proved to outweigh the benefits for the ultraviolet purification application desired. One particular challenge with this design came from the need for maintenance, cleaning, and repairing. While individual lamps could be taken on and offline at any point, greater difficulty came when needing to clean the walls of the concentric circle within the reactor itself. Smaller channels also proved problematic for the potential bottlenecking and back-flowing of influent water, two factors that could cause sediment buildup and clogging within the modular reactor. With the need for many smaller ultraviolet lamps, this design failed to minimize the energy demand for this system any more than previous designs. In fact, given the attempt to utilize LED point charges across the smaller radial distance between lamp and wall of the reactor, this system would require a greater amount of energy with increased circuitry complexity than any previous design. With this said, this patent application covers the apparatus described in [0098] through [0100] and all modifications made to this invention regarding the information disclosed within these listed paragraphs.

The Inspiration of DNA—once developing this design, the underlying inspiration for a helical design came when seeing a molecule of DNA. Recognizing that these concentric circles were an optimal baffling design, other considerations were taken for ways to maximize the exposure time for ultraviolet exposure. In this design process, we recognized that the concentric circle design could be further optimized if combining the radial distance of the design stated in [0095] through [0097] with the concentric circle pattern presented in [0098] through [0100]. Combining these two designs, prospects for design modifications came full circle when observing a DNA molecule and its helical pattern. This structure maximizes the rotations by which water travels maximizing the exposure time within the ultraviolet reactor while also maximizing the ultraviolet germicidal irradiance. Following this pattern, the helical design also would allow for one continuous flow of water through the system. As such, the natural weight of gravity would allow water to fall freely throughout the system, increasing the ability for intermolecular collisions without introducing additional structural components. It was in fact this design rather than any other competing commercial products, that inspired the baffling system enclosed in the patent application herein.

Tubular Lamping—utilizing this notion of a helical structure, one prototype under consideration was a helical ultraviolet lamp circulating around one central column of water. This design included the passing of water in one direct axial flow from influent to effluent without changing the direction of flow for the fluid. This design structure therefore maximizes the overall power irradiance coming from the ultraviolet light as the spiral lighting results in maximal irradiance to the central water column. Though the baffling does not increase the exposure time of ultraviolet irradiance on the water, such a design does not necessarily require this feature. In other words, the increased irradiance from the helical lamp design causes increased irradiance instead of increased exposure time, still ensuring an optimal exposure dosage to be reached. That said, the amount of energy needed for such a design is quite large with the creation of such a quartz lamp rather difficult, time-intensive, and energy intensive. At the same time, such a helical lighting design causes a great deal of wasted energy as the germicidal irradiance also passes radially away from the water flow. Additionally, such a design could increase the exposure of operators and other maintenance staff to ultraviolet irradiance dangerous to their health and safety.

Tubular Water Flow—if not having the lighting source circulate around a central water column, the final iteration of this design focused on circulating water resources around a central ultraviolet lamp. As water now flows in the helical path, it has the ability to increase the exposure time to germicidal irradiance to one compact ultraviolet lamp. At the same time, this waterflow can continually move and flow, increasing the chance for intermolecular collisions with a flow rate that modifies to accommodate to flow rate fluctuations as needed. Though an effective design, we found that such efforts still imposed limitations in the effectiveness of ultraviolet irradiance that now traveled farther radial distances away from ultraviolet lighting. Rather than having water exposed directly to the ultraviolet lamp, exposure was to a helical quartz tubing where the transmittance therein was unpredictable. Additionally, this design still proved to be cost ineffective and difficult to operate effectively since the manufacturing of a helical water tube required the same strenuous quartz shaping process as described above in [0102].

### BRIEF DESCRIPTION OF THE DRAWINGS

FIG. 1 is a top down view of an embodiment of the invention.

FIG. 2 is a bottom up view of an embodiment of the invention.

FIG. 3 is a side view of an embodiment of the invention.

FIG. 4 illustrates backflow baffling for a helical spiral according to an embodiment of the invention.

FIG. 5 illustrates baffling edges for a screwing mechanism according to an embodiment of the invention.

FIG. 6 illustrates an internal baffling perspective in accordance with an embodiment of the invention.

FIG. 7 depicts helical spiraling within an embodiment of the invention.

FIG. 8 illustrates a restrictive lining for ultraviolet lighting according to an embodiment of the invention.

FIG. 9 depicts a housing container for an embodiment of the invention.

FIG. 10 provides a bottom view of a housing container in accordance with an embodiment of the invention.

FIG. 11 shows an internal housing for a helical spiraling in accordance with an embodiment of the invention.

FIG. 12 illustrates a spiral lining of a container housing in accordance with an embodiment of the invention.

FIG. 13 is a diagram of a faucet connection as may be used in an embodiment of the invention.

FIG. 14 depicts a UV lamp modeled as a cylinder some finite distance from a differential element at which the irradiance is to be computed.

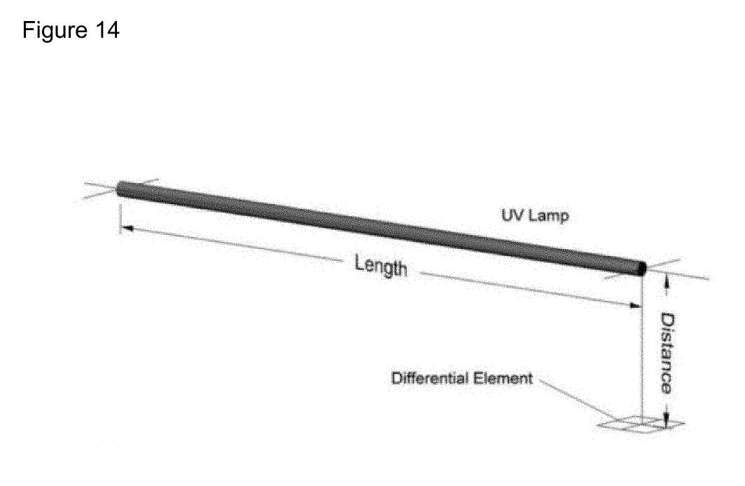

### SUMMARY

A portable, sustainable, and multi-scale water chamber utilizing the helical spiraling of a hand- or automated-screw structure encircling around an ultraviolet light to maximize the ultraviolet transmittance and minimize the exposure time for thorough ultraviolet germicidal water purification. In the application that follows, this document outlines a versatile, sustainable, purified water system whose primary function operates through the use of ultraviolet germicidal light. Disinfection is targeted towards but not limited to point-of-exit purification for flow-of-water resources including but not limited to standardized faucet couplings, urban infrastructure gutter/piping systems, natural surface water flows, and retrieved groundwater stores. This system uses the germicidal wavelength of ultraviolet light (UVC) to inactivate pathogens and other microbial organisms within water passing through the system. This is accomplished through the usage of an intricate water baffling design by which water, entering into a cylindrical container, flows through a helical screw-shaped water baffle revolving around a central ultraviolet light. Water flow can occur in either an upwards or downwards motion through the spiral with the spiral spinning or not spinning to accomplish this function and the entire device can have any perceivable orientation. This design's functionality specifically accomplishes the non-exhaustive list of the following tasks: 1) minimizing the transmission radius by which ultraviolet light interacts with water resources; 2) extending the exposure time for which water is exposed to ultraviolet light; 3) minimizing the dimensions, as much as possible, for any point-of-exit water purification system; and 4) maximizing the proximity by which ultraviolet light comes into contact with the influent water flow. Each of these functional components enables the system's operations to complete a narrow objective: maximizing the ultraviolet dosage projected onto water moving in any fashion through the device for the highest logarithmic inactivation of pathogens and microbial organisms in the shortest time possible. Comprised of only a handful of parts with the capacity to make one, continuous water baffling system, this invention stands alone against competing devices. This ultraviolet purification reactor describes a continuous helical component that can be manually screwed into and out from a larger container housing component. This helical component, which contains a perpendicular edging along the periphery of the baffling surface, serves to baffle water flow for the purpose of increased exposure time. This increased exposure time, in combination with the germicidal irradiance moving radially from the center of the spiral, maximizes the exposure dosage place on this water. The container housing component creates the outer confines of the ultraviolet reactor, containing water within the baffling structure as it spirals from the influent inlet at the top of the device to the effluent exit at the bottom of the device. This housing also consists of a helical lining whereby the helical component can rest and lock into place to develop one continuous and complete ultraviolet reactor. As these two structures conjoin together, no separation exists between the confines of the container walls and the spiral baffling, maximizing the efficiency of water flow within this system. In the embodiment drawn, inlet water flows into the system through a narrow inlet hole. Here, a hexagonal nut fastens around threading along a through-pipe nipple with the opposite threading having the ability to be connected to any faucet or similarly threaded structure. Ultraviolet lighting resources can be placed at the cross sectional center of the cylindrical housing whereby equal exposure dosage is provided equally to all perpendicular radial axis along the entire longitude of the lighting resource.

### DETAILED DESCRIPTION

To provide adequate explanation to the various subcomponents within this system, all detailed explanations will be provided on an individual figure-by-figure basis. Through this manner, each figure can articulate a particular functional and operational process or design specification to maximize the purification of water. As explanations tailor across figures and designs, all numerals or letters used for the demarcation of a specific system component or process will only be used once. The repeated discussion of a component will thereby be the same as referenced previously within this subsection. Designed specifically for its functionality, operability, and modularity, intellectual property rights are declared for any dimensional modification made for all figures alluded to herein. Additionally, as the orientation of such a system is contingent upon the system's application, installment environment, and underlying purpose, all influent and effluent couplings can be located on any portion of the container housing component.

Before any embodiments of the invention are explained in detail, it is to be understood that the invention is not limited in its application to the details of construction and the arrangement of components set forth in the following descriptions or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. No colors shown in the embodiments that follow have any indication of the final color or design in the final technological invention described herein.

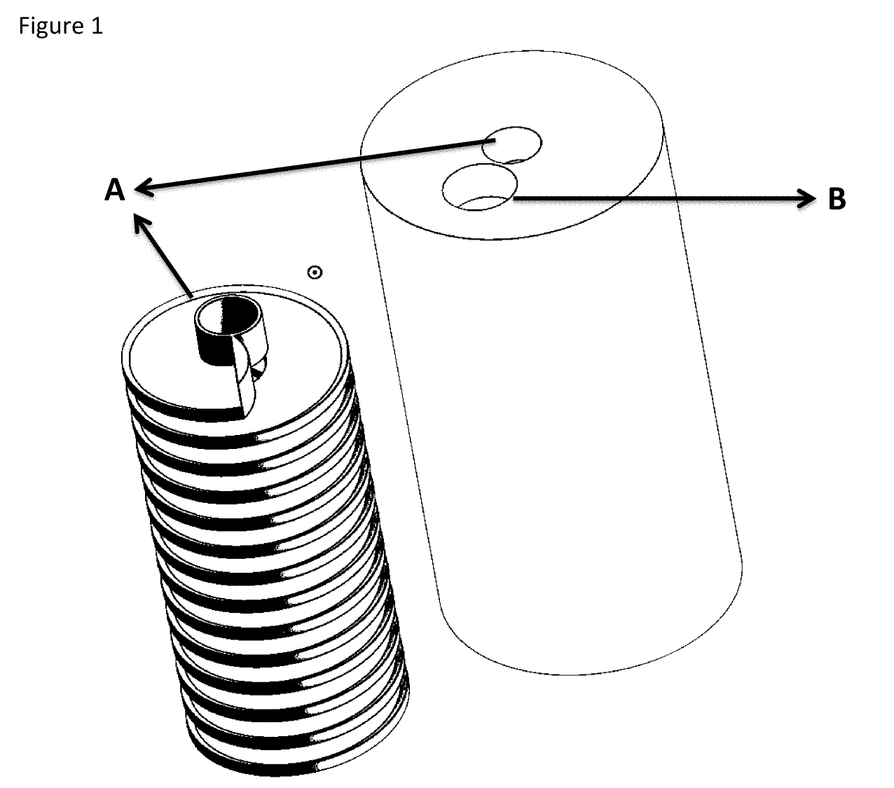

FIG. 1—Referring to FIG. 1, an embodiment of the ultraviolet reactor shows the orientation of the helical spiral component in relation to the housing component. As is denoted under demarcation A, the spiral component screws from the bottom of the housing component up to where the two faces meet. Here, an ultraviolet lighting mechanism can be placed through A where it then runs longitudinally perpendicular to the top facing of the housing component. The preferred ultraviolet lighting mechanism is a proprietary instrument developed by Light Source Incorporated known as their RPT lamp model. That said, this embodiment covers any alternative lighting fixture placed in either an upwards or downwards orientation at the point of demarcation A. Adjacent to this location, demarcation B identifies the inlet channel by which water flows into the system. The radius of this influent channel, as with the radius of the lighting channel shown in A, can fluctuate to accommodate to any flow-of-water circumstances including but not limited to all variations in size changes for faucet sizes, perpendicular piping, effluent from a filtration device, or the like. Though not shown in the embodiment, the inner lining of B can be threaded or unthreaded according to the demands and needs of the influent piping. This application also covers any modification made to the facing shown on B or the specifications of A and B to include an addendum power resource, filtration device, flow regulator, or any apparatus whose function and operation in tandem with this invention improves the invention's overall functionality.

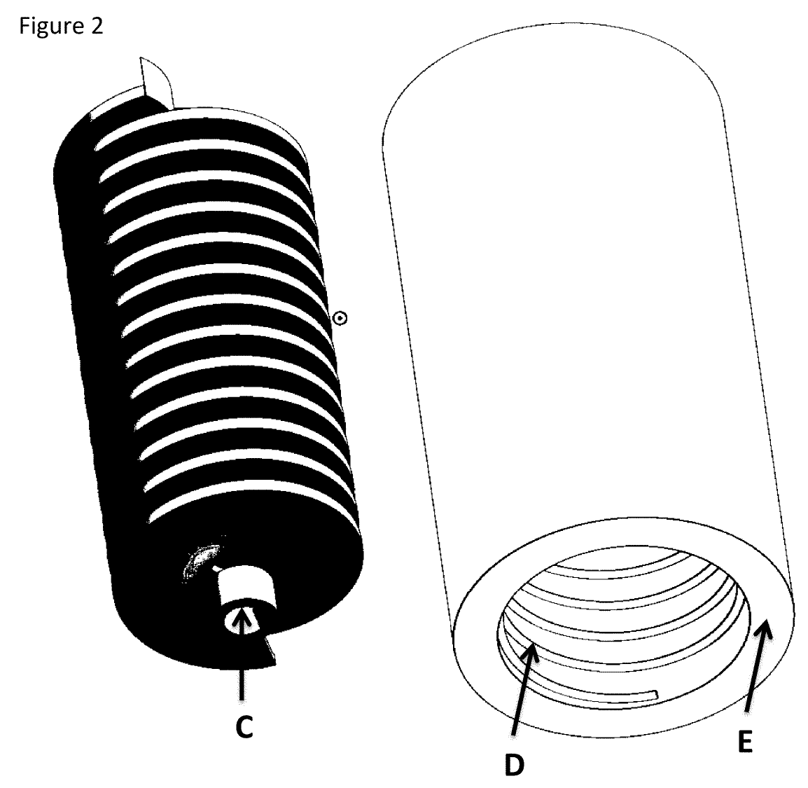

FIG. 2—Referring to FIG. 2, this embodiment shows the bottom facings of the ultraviolet lighting through a cross sectional cutout. Recognizing the openness of the device, this application seeks intellectual property over any modification made to the bottom of either the helical component or housing container component for all improvements in functionality and operability including but not limited to securing an ultraviolet lighting mechanism, connecting to a water storage tank, being attached to an additional apparatus, or being enclosed for narrow flowing of water through a more restricted channel or pathway. With this said, demarcation C shows one embodiment of the device for which a multi-pinned ultraviolet lighting mechanism can be rested on. This structure shown in C can serve as a catching property to the spiral component, allowing straight-edged ultraviolet lighting mechanisms to be placed at the center axial of the spiral and rest atop C to allow security and stability of the lamp. Additionally, demarcation C reflects a protective sleeve that can serve the purpose including but not limited to the protection of electrodes of ultraviolet lights, protecting of electrode pins for ultraviolet lights, or the protection of electrical wiring used to power ultraviolet lights.

Also referring to FIG. 2, demarcation D shows the inner lining of the container housing component in which the spiral housing rests. To provide one continuous structure, the helical component is passed into the container housing in this bottom manner, screwing through the threads shown in demarcation D to remain securely held within the housing. Recognizing that small gaps between the helical spiral component and internal helical lining of the housing component can become a possible location for microbial growth or buildup in the system, this application covers modifications made to improve the performance of, reduce the microbial contamination within, and increase the efficiency of the screwing of the helical component. Such also includes modifications made to make the screw rotate or pull water in the reverse direction up the reactor, as would be done in the case of an Archimedes screw. On a similar note, demarcation E shows the thickness of the housing container that serves purposes including but not limited to providing durability for the device, providing protection for operating staff, to provide protection to the helical baffling, and to provide the opportunity for connection with other apparatuses. Recognizing that this device may be inserted into a pre-existing water management systems, combine with other apparatuses to improve water purification, or may need to be adapted for better installment in the environment/vertical as needed, this patent application covers modifications made to the thickness of the container housing component as shown in demarcation E to increase the transportation, storage, purification, or otherwise of water resources within this device. Additionally, this patent application covers any housing compartments, chambers, or the like attached or implemented at the bottom facing of the housing container as shown in Figure Two for the baffling, redirection, narrowing, widening, or the otherwise change in direction of water resources leaving the device.

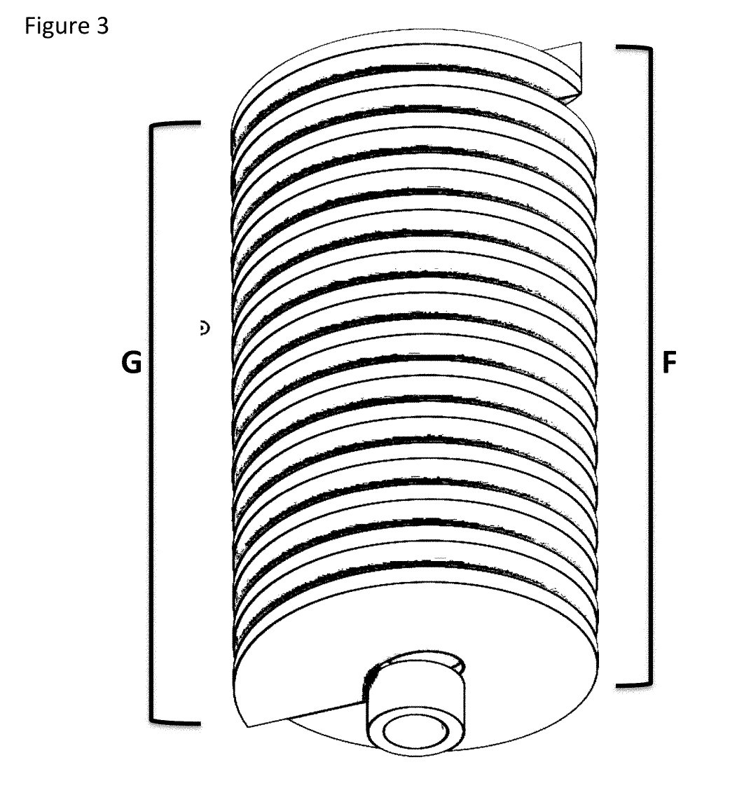

FIG. 3—Referring to FIG. 3, this embodiment shows the side view of the spiral housing component whereby one can recognize the varying spiral edges and rotations of the helical design. As shown in demarcation G, the height of the spiral has not been defined with a particular dimension. This is because the overall length of the spiral housing, and thus the container housing, will adjust to accommodate for the overall exposure time needed in the device, largely influenced by the germicidal irradiance provided by the ultraviolet lighting resource. Additionally, this height will fluctuate in accordance to the environment in which the device will be implemented in and the rigor by which water must be purified within the device. As such, this application covers all variations in the dimensional height for this device in coordination with fluctuations in installment capacity and ultraviolet exposure dosage. To a similar extent, demarcation F signifies all rotations made by the spiral device, again made arbitrary in the embodiment as this application seeks to cover all functionality and operability of such a device. Taking this into account, this patent application covers all modifications in the number of rotations made by the helical baffling component as denoted in F. These baffles and the rotation number denoted in F serves the purpose of increasing the exposure time of water within the ultraviolet reactor thereby increasing the exposure dosage placed on pathogens and other microorganisms within the water.

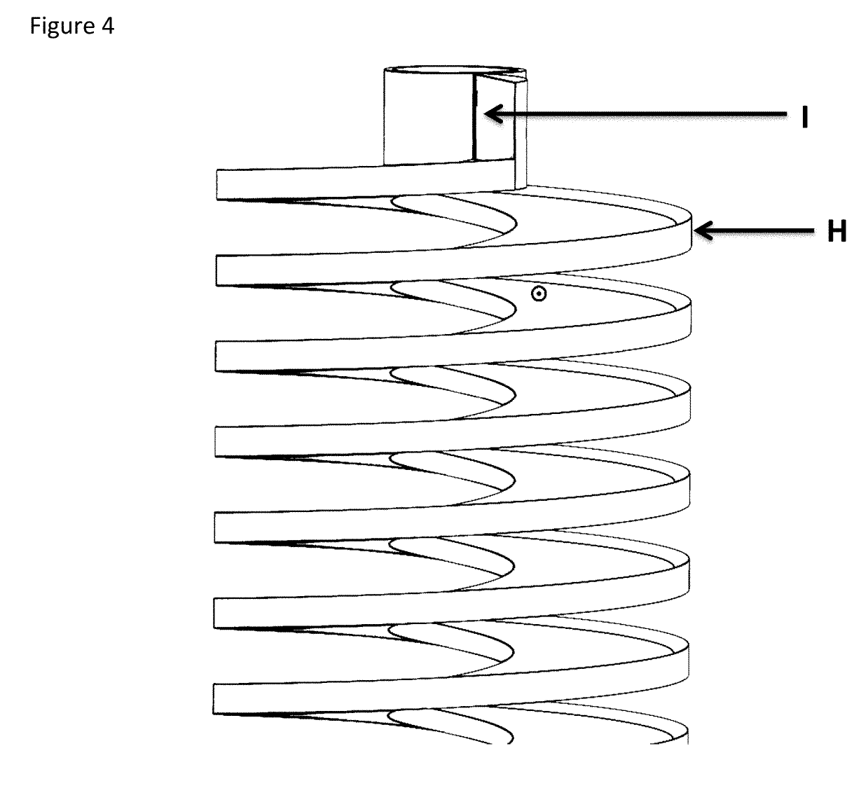

FIG. 4—Referring to FIG. 4, this embodiment again shows the side view of the helical baffling component however from a perspective that more adequately exemplifies key features of the baffle itself. As noted in [0123], this baffling serves the purpose of directing the flow of water through the ultraviolet reactor in a way such that the exposure time of water to the ultraviolet light through the axial center of the device can have an increased ultraviolet exposure dosage. As shown in demarcation I, this device also contains a backflow baffle, preventing water that enters through demarcation B from traveling in the direction opposite the flow of the helical baffling. This backflow baffling denoted in I ensures that all water entering into this device obtain the maximum and intended exposure time to the ultraviolet germicidal irradiance. To ensure the stability of this backwards baffling, this structure is connected to the edge of the helical baffle though its location can adjust to any place along the helical baffle as needed. Additionally, this backwards baffling as denoted in I is also connected to the protective encasing around the ultraviolet light serving the same function as demarcation C though on the opposite end of the helical component. As this protective encasing may or may not be necessary in the design depending on the ultraviolet lighting mechanism used, this patent application covers all modifications made to the backwards baffling structure shown in demarcation Ito improve the functionality and operability of this device's design.

Also referring to FIG. 4, demarcation H shows the thickness of the helical baffling component for each of the helical baffle rotations. This thickness includes both the flat edge of the helical baffle itself as well as a perpendicular vertical edging along the periphery of the baffling structure to enable easier screwing capacity of the helical component into the housing component. The thickness of the baffling structure shown in H serves the purpose of increasing the stability of the helical design, providing a ridge for which the helical baffling can sit within the housing component, provide guidance for water along the spiral flow pattern, and to increase the tensile strength of the design under the weight of influent waters. As any of the aforementioned functions may require the changing of the depth of such thickness, this patent application covers all modifications made to the thickness of the baffling helical spirals for purposes including but not limited to increased stability in the housing component, increased structural strength, increased resistance to water weight, and improved functionality/operability of a spiraling water flow.

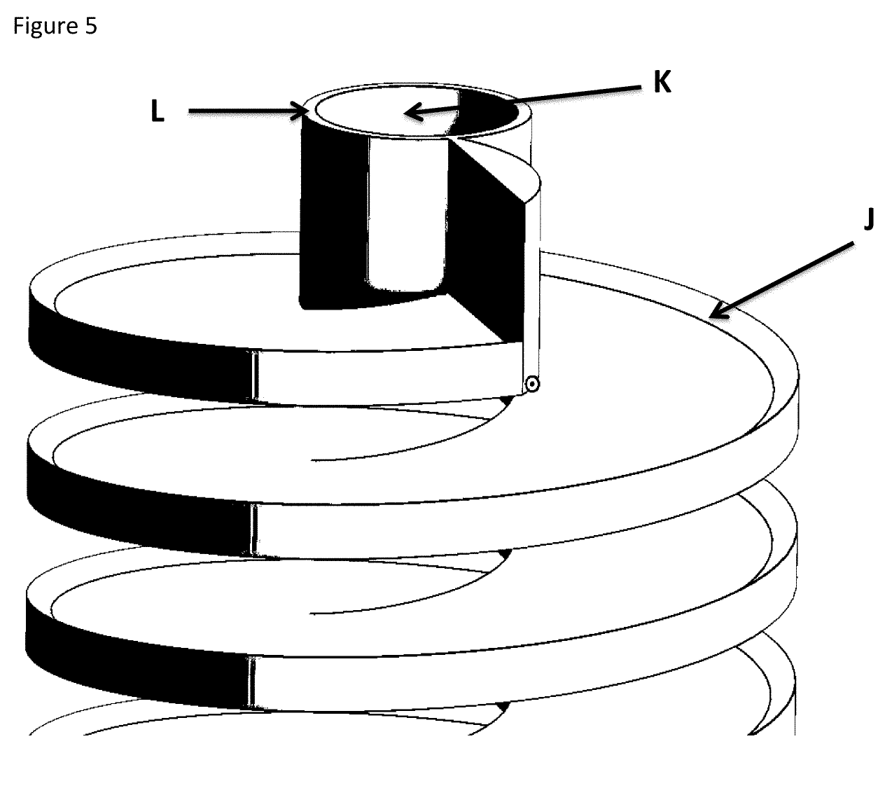

FIG. 5—Referring to FIG. 5, this embodiment shows again the helical component with specific exemplification of the perpendicular edges and inner lining of both the helical baffling and potential protective sleeve for ultraviolet lighting mechanisms. As seen in demarcation J, the helical baffling contains a perpendicular edge lining to help guide water down (or up) the spiral. With the obtuse slant shown in this embodiment, water can guide through the helical component without becoming trapped between or passing into gaps between the helical component and housing component. Additionally, these raised edges allow for the helical baffling to more easily be guided through the housing container. As this edging can be lined in any number of ways, this patent application covers any modification made to this peripheral edging including the removal thereof to improve the functionality and operability of the ultraviolet purification device.

Also referring to FIG. 5, demarcation L and demarcation K represent an embodiment of the design including a protective sleeve around the end of an ultraviolet lighting mechanism. As noted earlier in [0121], this protective sleeve serves the purpose of potentially protecting any property of the ultraviolet lighting mechanism including but not limited to the electrical wiring, electrodes, or electrode pins used for the lighting mechanism. Whereas [0121] references this sleeve at the bottom of the helical baffling component, a similar protective sleeve (attached or independent from the helical baffling) can be utilized at the top of the helical baffling as well to serve the same purposes. As highlighted in demarcation K, this protective sleeve can have a smooth internal lining or be altered or modified to include alternative designs including but not limited to a snapping/locking security feature, internal threading to serve the purpose of screwing into another device, or the increase or decrease of this structure's height for more or less exposure of water. Demarcation L shows the thickness of this protective sleeve, narrow in this embodiment so as to fit snuggly around an ultraviolet light. Given the ideally double quartz protection of an ultraviolet lamp, this protective sleeve and its appropriated thickness may be irrelevant. That said, this application addresses any modification made to the thickness, length, and other dimensions or changes to the protective sleeve and its thickness shown in demarcation L to improve the functionality and operability of the ultraviolet purification device.

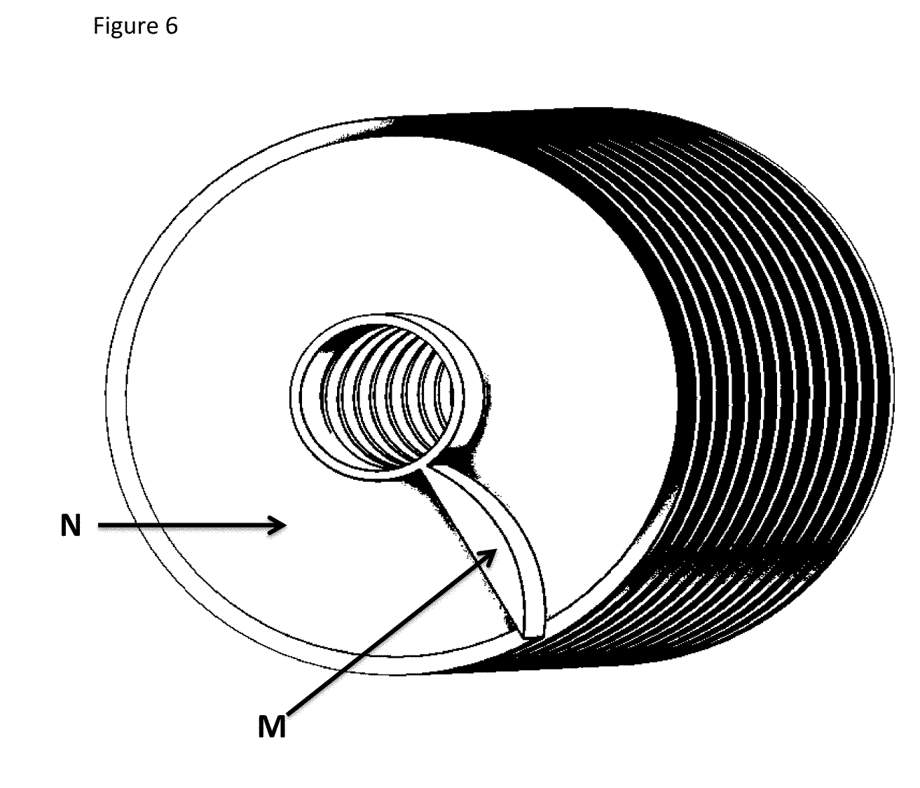

FIG. 6—Referring to FIG. 6, demarcation M is an extension to [0127] reflecting the top-down, birds eye view of the backward baffling design previously described in [0124]. As indicated in demarcation M, the shape of this backwards baffling is that of a half moon or crescent for ease of attachment to the helical baffling structure. This patent application covers any change in shape, size, dimensions, attachment points, orientation, or otherwise for this backflow baffling structure so as to improve the flow of water through the helical component under the premise of the functional and operational goals of this system. Similarly, this application covers any modification made to the radial dimensions, shape, size, angle of flow, or change in size relative to the size of the lighting fixture hole denoted in A for the overall helical component's cross sectional area as denoted in N. The cross sectional surface area of the helical baffle has two purposes, each purpose competing with the other. On the one hand, the cross sectional area shown in N for the helical component is meant to be as wide as possible to maximize the potential flow of water through the system and thereby increase the volume of water that can be purified within the system. On the other hand, this same cross sectional area denoted in N must be as small as possible to maximize the germicidal irradiance and exposure dosage of ultraviolet light on water passing through this system. Recognizing this trade-off between the functional aspect of water purification and the operational aspect of maximizing water volume, this embodiment, as with all others shown in this patent application, lack specific dimensions for which the system operates by. In other words, this patent application intentionally fails to provide dimensions for a specific design as the tradeoff between these two aspects in light of the changes made to apply this system to a given vertical.

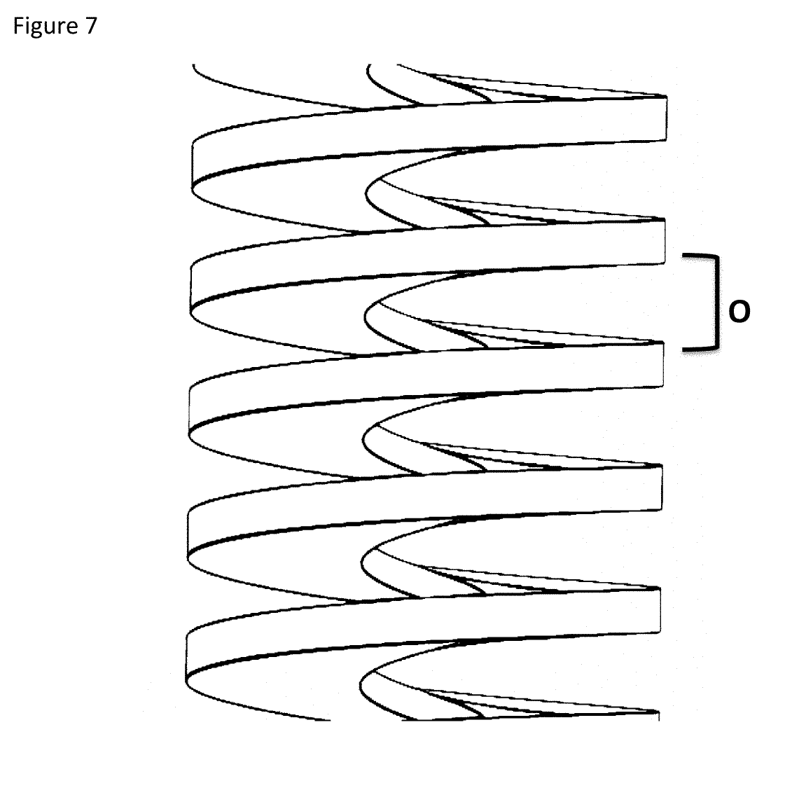

FIG. 7—Referring to FIG. 7, this embodiment again offers another visual of the helical baffling component of the system to show the side perspective of the spiraling of this component. Looking closely, one can see the central hole in the spiral that allows for an ultraviolet light to pass down the axial center of the baffling component. Additionally, one can see that due to the straight longitudinal orientation of the ultraviolet light, all radial distances between the ultraviolet lighting mechanism and the housing container around the peripheral edge of the helical baffling component are equivalent. As such, the maximal radial distance by which ultraviolet light travels is equivalent throughout the entire device, preventing the development of any dead zones of over- or under-purified water. Shown in demarcation O, the vertical distance or compaction of the spiral is set to an arbitrary dimension directly related to factors including but not limited to the length of the helical component, the thickness of the baffle edging, the number of desired rotations in the device, and the germicidal irradiance of the ultraviolet lamp. As with all these aforementioned factors, the distance between spiral rotations as seen in demarcation O will change in accordance with the needs for the functionality and operability of this design. As such, this application covers any modification made to the dimensions or changes to the distance between helical rotations shown in demarcation O to improve the functionality and operability of the ultraviolet purification device.

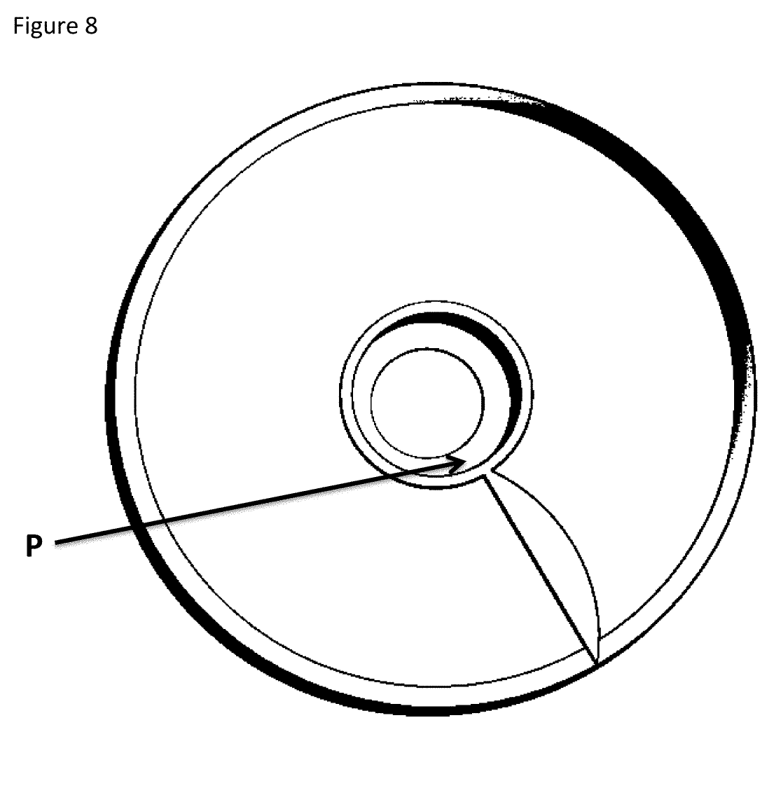

FIG. 8—Referring to FIG. 8, this embodiment shows the top-down perspective of the helical baffling with a line of sight passing from the top of this structure through the central column of the structure and out the bottom. Given the straight orientation of the ultraviolet lighting mechanism intended for this design, one can see no spiral or helical grooves or rotations for this design. Though shown in this embodiment, such alterations may be made to accommodate for varying structural dimensions of ultraviolet lights including but not limited to “U” shaped lamps, non-linear lamps, or circular lamps. As shown in demarcation P, an internal lining can be placed within the protective sleeve at the bottom of the helical baffling component, a structure previously described under demarcation C in [0121]. This narrow internal lining can easily be constructed for the device with the purpose of being slightly too narrow of a radius in comparison to the radius of the ultraviolet lighting mechanism. As with the entire protective sleeve, this inner lining radius can be altered both in the radial and longitudinal directions to provide increased functionality and operability of the purification system. Irrespective of changing in dimension, this inner lining allows for ultraviolet lighting mechanisms particularly but not limited to those straight edge lamps without the socket and base structure described under U.S. Pat. No. 7,569,981 B1 to rest securely in the container. This inner lining, especially at the slightly smaller radius, also reduces the required maintenance on or slippage of the lamp. The facet of the protective sleeve shown in demarcation P under this embodiment may or may not be necessary for the implementation and installment of this device.

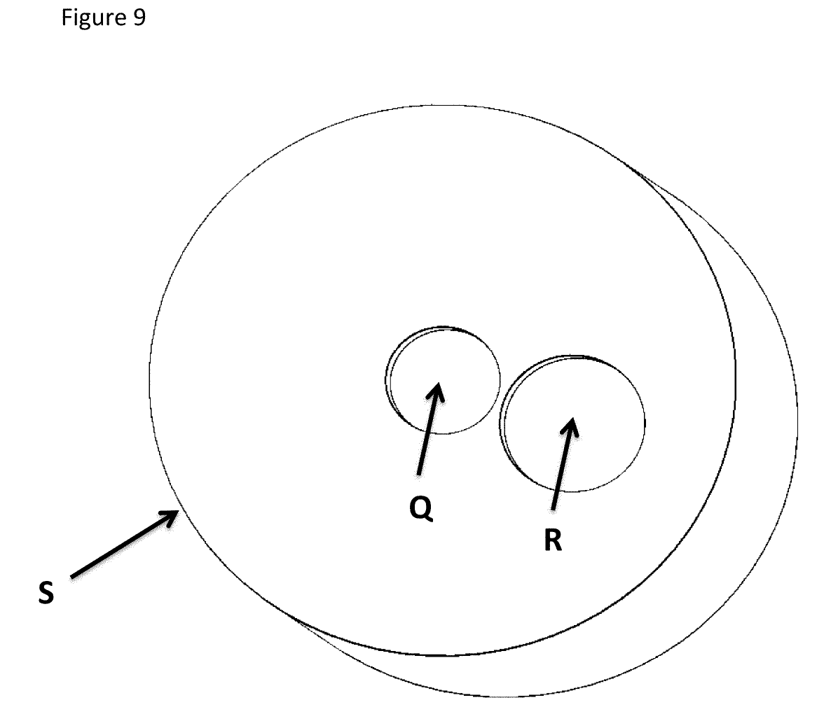

FIG. 9—Referring to FIG. 9, this embodiment now transitions towards evaluating the technical specifications of the container housing component of this ultraviolet system. This housing component serves as the external confines of the ultraviolet system within which all water flows and becomes purified. Whereas demarcation A and B of Figure One identify the functional connection between the helical and housing components, demarcation Q and R identify how these specification, respectively, function in isolation of the helical baffling component. As shown, demarcation Q reflects the throughway for which an ultraviolet lighting mechanism can pass through the center of the spiral baffling system. This throughway allows for a lighting mechanism to be fixated to the top of the purification system along the external confines of the housing component. The radius of this throughway can adjust in accordance with factors regarding the ultraviolet light including but not limited to the diameter of the ultraviolet light, additional width added by protective quartz sleeves, additional connecting apparatuses or mechanisms attached to top of the light, or electrical wiring and the like traveling to electrodes along the ultraviolet light. The hole found in demarcation Q may also be modified to allow for additional alterations not shown in this embodiment including but not limited to multiple straight edge lamps to be connected in tandem, connection of a power supply to the top of the housing container component, or structures used for securing any additional fixtures to the top of the housing component. That said, this application covers any modification made to the thickness, length, internal lining, and other dimensions or changes to the inlet hole for ultraviolet lighting mechanisms as shown in demarcation Q. Additionally, the orientation of demarcation Q and the container housing component in general can adjust to be along any surface and any axial imagined beyond that shown in this embodiment.

Also referring to FIG. 9, demarcation R shows the water inlet hole as noted earlier via Figure One in [0120]. This hole provides an inlet for water resources into the purification system to allow for water to flow naturally and ideally in a laminar flow profile through the helical baffling device. This hole is extremely important as it is also the junction by which the water resources will be connected to the modular purification device. Further description of this through piping connection has been illustrated in Figure Thirteen and explained in [0137] through [0138]. Most importantly, demarcation R and the water inlet hole it represents can be modified and adapted to regulate the flow of water into the system. In order to ensure a long enough exposure time of water to ultraviolet light in addition to other important factors including but not limited to the pressure placed on attachment coupling, the security of attachment to water resources, and the tensile strength and durability of the baffling structure, this hole can be modified by including a flow regulator that decreases or increases the rate at which water flows into the purification system. As the water resources used in this system will vary, that additional expenditure in addition to any micro-controllers or sensors used to collect monitoring and evaluation data regarding the functionality and operability of the system, are critical alterations made to this device. That said, this application covers any modification made to the thickness, length, internal lining, and other dimensions or changes to the inlet hole for influent water resources as shown in demarcation R. Additionally, the orientation of demarcation R and the container housing component in general can adjust to be along any surface and any axial imagined beyond that shown in this embodiment in accordance to wherever influent water can most easily enter into the system.

Again referring to FIG. 9, demarcation S shows the flat edge top of the housing container for this ultraviolet light water purification system. Like demarcation Q and R, demarcation S represents an extremely important and extremely adaptable component of this system. First and foremost, this housing protects influent water from exposure to airflow, contains water within the top of the purification device and most importantly provides a flat edge top to the purification system. Secondly, the radius, thickness, materials, size, and shape of this housing can be adapted in order to maximize the functionality and operability of the system in accordance and similarity to the helical housing component that fits therein. Third, this facing provides the possibility of housing, connecting, attaching, and mating in any way additional apparatuses important to the functionality and operability of this device including but not limited to filtration systems (definition of filtration provided in [0027]), power-operating systems and/or their electrical components (such as but not exhaustively including solar powered systems, battery packages, hydroelectric turbines, flow regulators, ballasts, or the like), monitoring and evaluation equipment and/or their electrical components (such as but not exhaustively thermometers, LED screens, micro-sensors, flow meters, chemical agent injectors, or the like) or additional piping and water storage mechanisms. Such apparatuses can be connected to this housing container along demarcation S (or any other orientation to this device) through means including but not limited to screwing mechanisms, adhesive compounds, mating materials such as glue, screws, nails, etc., as one continuous design molded into the purification system, or via locking/snapping mating. That said, this application covers any modification made to the thickness, length, internal lining, and interconnected apparatuses or other interlinkages with additional materials outside the scope of this technological innovation to the top edge of the housing container component as shown in demarcation S.

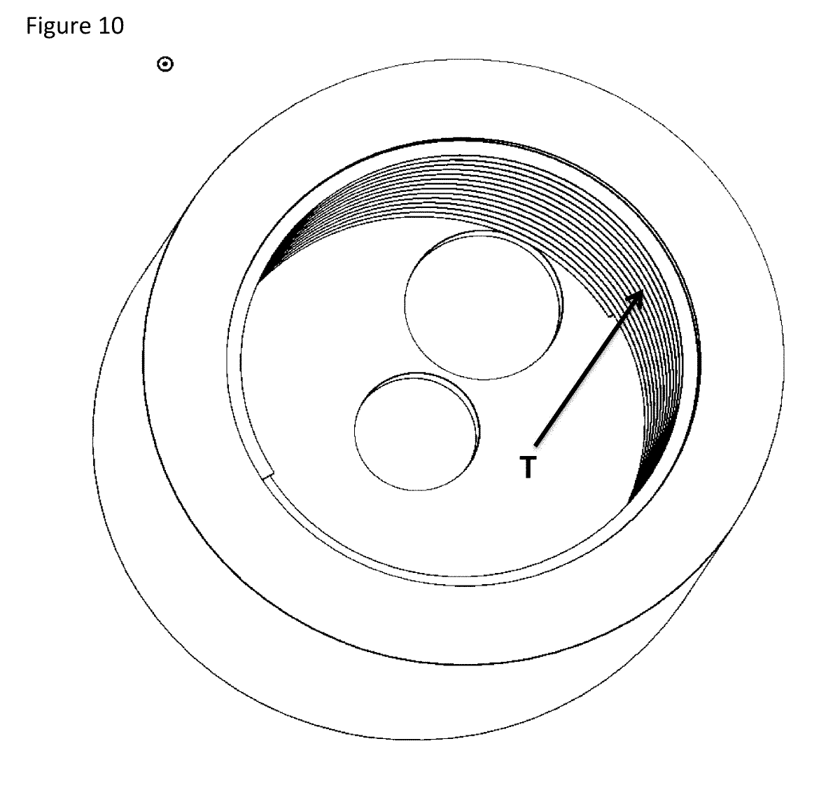

FIG. 10—Referring to FIG. 10, this embodiment shows the bottom view upwards looking into a cross sectional cutout of the internal component of the container housing component. Within this housing, one can see the internal helical lining for the housing component, noted via demarcation T. This lining provides a means for which the helical baffling can be screwed into and out of the purification system. As seen in demarcation T, these grooves have a thickness wide enough to allow for the helical baffling structure to rest upon the internal housing lining, increasing the security and stability of the system as the helical component edges rest along these grooves. As was noted across the entire explanation for the embodiments of the helical baffling component, the spacing, thickness, number of rotations, the longitudinal height, the radius, and all other dimensions regarding this internal groove structure is free to change in accordance with optimal functionality and operability within the system. Additionally, this patent application covers all modifications made to the coating and lining of this internal housing including but not limited to the application of chemical agents, titanium dioxide or other photocatalytic agents, and any chemical, coating, paint, of layering applied to this internal structure to increase the photochemical reactions, hydroxyl formation, photocatalytic reactions, or advanced oxidation process occurring to the water flowing through this system.

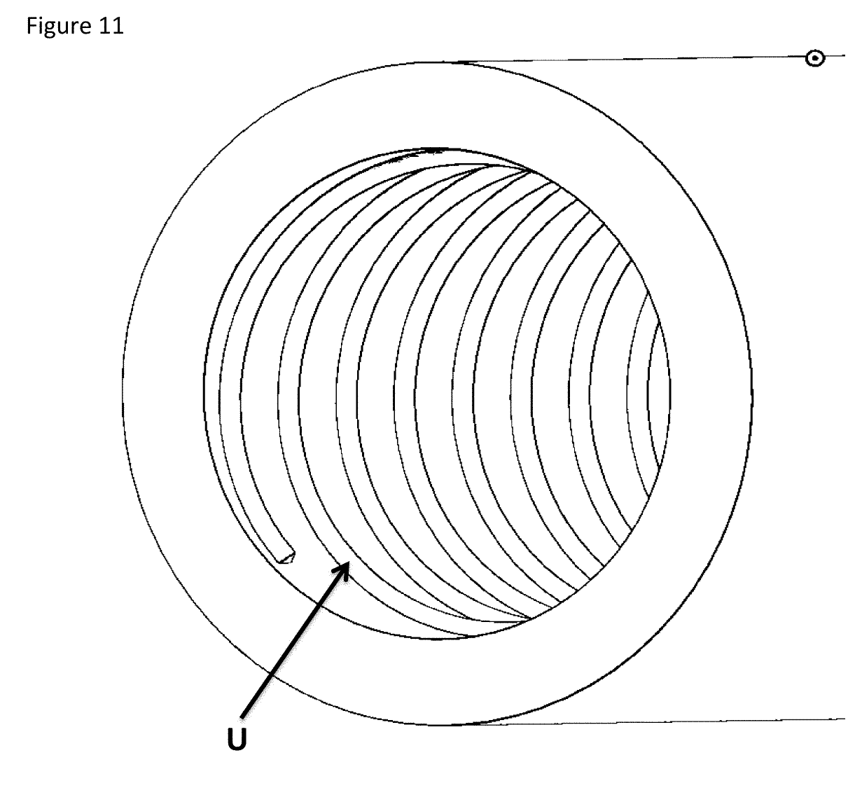

FIG. 11—Referring to FIG. 11, this embodiment shows another bottom-up perspective of the ultraviolet purification system that particularly highlights, again, the internal lining of the container housing component for this device. As shown in demarcation U, the lining of this structure rotates in the orientation horizontally around the internal component of the housing container component to match the horizontal baffling of the helical component. To offer maximum security, the edges for this internal lining are also straight-edged though manipulations can occur herein to allow for more rounded edges to provide better rotation of the helical baffling component within this housing. Most importantly, the orientation of this internal groove structure within this housing component can change to run perpendicular to the longitudinal direction of the container or lie in a completely different orientation according to the changes in orientation made to the container housing. That said, this application covers any modification made to the thickness, length, internal lining, and other dimensions or changes to the internal helical grooves within the housing container component as shown in demarcation U.

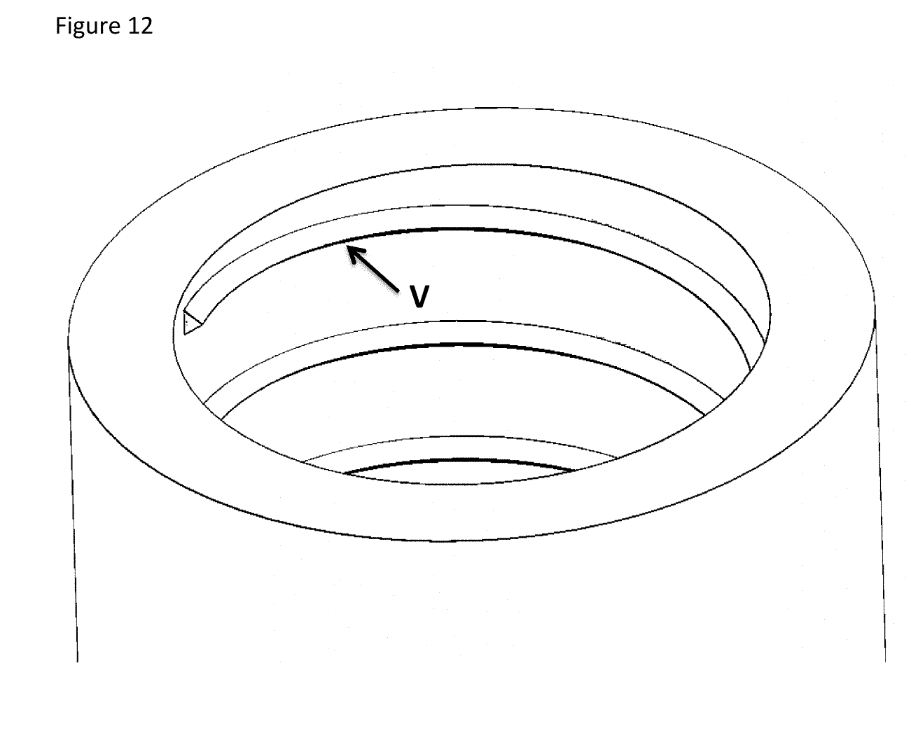

FIG. 12—Referring to FIG. 12, this embodiment shows the revolved triangular shape of the grooves for the internal housing structure within the water purification system. As seen in demarcation V, this internal groove is developed from a triangular shape revolved in a spiral pattern throughout the entire length of the housing container component. As briefly mentioned in [0135], the shape and lining of this structure is subject to change in accordance with what is needed for the structural integrity, functionality, and operability of the water purification system.

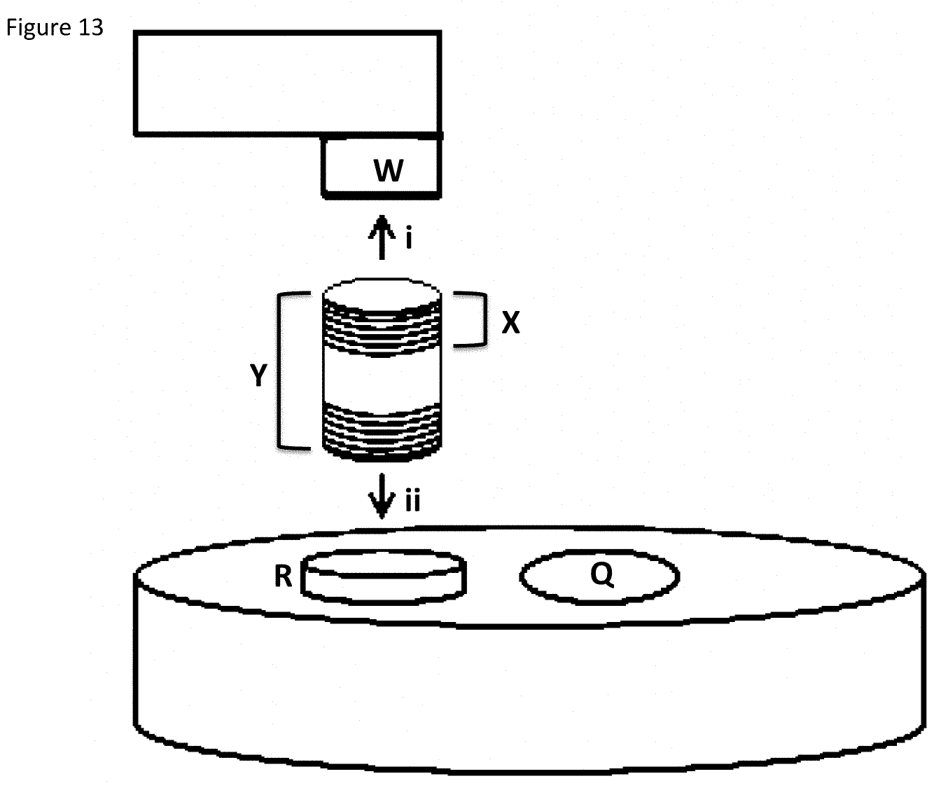

FIG. 13—Referring to FIG. 13, this embodiment shows one possible way for which this water purification system could connect to a water faucet or similarly threaded water dispersement system. It should be noted that this embodiment reflects merely one possible means of connecting this water purification system to an outside water resource and adaptations and modifications to this system can be made while still falling under the scope of this patent application. As the embodiment shows, water apparatuses with or without threaded linings shown under the demarcation W which presents a water faucet but can include any water dispersement system. Such a connection, as shown in the process indicated in i can occur through any means of attachment, adhesion, or mating though within this embodiment, such a process is shown through the threading of this through pipe denoted in Y. In the context of threading, any connection made in process i can adjust to the threading and lining for any standard or non-standard screw or threading, most prominent of which is assumed to be ½″ or ¾″ lining. If using this through pipe mechanism to connect the water dispersement system to the purification system, this apparatus, adhesive, or otherwise mating mechanism must secure the purification system to the water dispersement system without any influent airflow, potential spillage of water, or leakage of any kind that may jeopardize the integrity of the functional or operational means of the system.

Also referring to FIG. 13, the more specific ramifications shown in this embodiment reflects the threading of the through pipe under demarcation X of the piping denoted under Y which connects to demarcation W via some process i. In the case of this through pipe threading, a metal through pipe will be inserted through the inlet water hole denoted under R via the direction and process of ii. Here, the center of the through pipe between the top and bottom threading of Y will traverse the thickness of the holding container component, leaving threading available on both sides of the through pipe. Within the holding container on the underside of the inlet water hole denoted in R, a hexagonal wingnut of the same radius as R will be fastened to the bottom threading of the through pipe. This wingnut, denoted under Z, will undergo the connection process iii to connect to the through pipe, indicated in this embodiment as a screwing mechanism along the threading of the through pipe though having the ability to be mated in any means necessary. Using this wingnut shown in Z, the through pipe can be secured within the internal structure of the water purification system, successfully connecting the disbursement water resource to the water purification system and water housing container component along the inlet hole denoted as R. Given the force of gravity on the system, the wingnut connected underneath the housing of the container provides the necessary support to hold the purification in connection with the water resource, irrespective of additional housing or support structures that can ensure the stability of this system at large. That said, this application covers any modification made to the water purification system to allow for optimal functionality and operability in accordance with the same functional, operable, and conceptual goals as those outlined in Figure Thirteen by demarcations W, X, Y, and Z via the processes i, ii, and iii.

Application of Sustainable Efforts

The following sections from [0139] through [0148] take into consideration all applications and operability of this system to enable maximum efficiency and effectiveness for the underlying sustainability purpose of this system. As a reminder, the technical definition used for sustainability has been described in full detail in [0028] above. More specifically, the hope of the aforementioned paragraphs within this section are to outline the different means by which this device will be powered as well as the different customer channels for which the system can be used. Though the specific electrical wiring and explanations have not been given in full, this remains an intention by the inventors when constructing this patent application. The reasoning is that such efforts enable all power applications within this type of power resource to remain within the intellectual property domain and integrity of this technological innovation. As power and energy mechanisms and techniques are continuously changing and adapting, we attempt to secure the functional and conceptual manipulation of this device towards certain power resources rather than define one particular operable condition of this power resource. To do so would only limit the capacity and intellectual property domain of this patent as well as minimize and undermine the intellectual thought given to such power and customer applications within the product development process.

Solar Applications—the most widely cited application for alternative, off-the-grid power applications comes from the harvesting of solar energy through any form of solar irradiance. These applications have predominantly though not exhaustively been focused on the use of solar photovoltaic, solar electric, or solar thermal power mechanisms. The first of these applications, solar photovoltaic cells, parallels though is not exclusively replicative of the positive and negative diodes and junctions as LED lighting described in [0071] above. The second application, solar electric, utilizes the direct solar irradiance of the sun to concentrate light on one specific working fluid that, when boiled and converted into steam, has the ability to effectively power a steam turbine or the like for energy production purposes. The final solar-based power application, solar thermal, tends to focus on the creation of electrical energy through a passive approach whereby solar irradiance is used to passively heat a working fluid or surface with the exothermic release of this energy being used for electrical production. In any of these power applications, solar energy can serve as an easily installed, abundantly available, sustainable renewable resource for powering the technological device enclosed herein. Additionally, as these panels can be implemented on any means of infrastructure for collection, flexibility exists for which such a device can be implemented without impeding on the infrastructural constraints already existing at an implementation site. As this system requires an extremely smaller power supply relative to the available solar power from direct irradiance and relative to other common electrical applications, solar panel cells and sizes can adjust according to the needs of the system and availability at the location site. With this in mind, this application covers any implementation, usage, modification, alteration, functional purpose, or operation via the technological device described herein for the purpose of disinfecting, purifying, or otherwise inactivating pathogens or microorganisms through any solar power related energy resource or application therein.

Hydroelectric Applications—one readily accessible power resource for this device includes the implementation of hydroelectric power supplies. Such power applications can be obtained using the kinetic energy provided from water resources including but not limited to the pressure from a water faucet, falling water through a gutter or distribution center, or any other conversion of kinetic, potential, or mechanical energy for the use of hydroelectric power resources. Though water serves as the resource of importance for the system, this flowing fluid can be used in combination with a water turbine with designs including but not limited to hydrokinetic propellers, pelton turbines, kaplan turbines, francis turbines, water wheels, or turgo turbines. Such turbines use the kinetic, potential, or mechanical energies of water and converts this energy into usable electrical energy due to the forces of the water on the turbine pedals or blades. Such applications also allow for water flow rates to be reduced as all energy of water from hitting these turbines is lost in the circulation of said turbines. This inherent property of these turbines thereby allows for regulation of water flow rates before or after filtration devices, before or after the ultraviolet reactor described herein, or at any other location in the distribution process of water from one location to this technological device and the system applied therein. With access to this hydroelectric power source, energy resources can then be implemented either directly into the system via electrical wiring or be preserved through addendum battery applications/mechanisms. With this in mind, this application covers any implementation, usage, modification, alteration, functional purpose, or operation via the technological device described herein for the purpose of disinfecting, purifying, or otherwise inactivating pathogens or microorganisms through any hydroelectric power resource including any plausible turbine or hydroelectric-affiliated power harvesting mechanism.

Battery Operation Applications—though energy resources can be acquired through any number of means or resources, sustainable or unsustainable alike, batteries offer the most well-known and abundantly applied way of preserving energy resources. By implementing batteries within the operations of this technological device, power can be supplied to the ultraviolet lighting mechanism at any frequency, voltage, current, time of day, or duration within the confines of the chemical and operational capacity of the battery itself. As such, the implementation of battery-operated electrical energy improves the sustainability of this system with regards to the long-term implementation and usage of power resources for this technology. In other words, whereas direct connection of intermittent power supplies can provide disinfected water intermittently or for one-off usages, a battery operated system can provide sustained, consistent power supplies and operational capacity for long-term purified water. This means of powering this system thereby allows for consistent access to purified water resources consistently on-demand at the time of need for the duration of need necessary by the user within the feasibility of the battery used. Additionally, the use of battery applications allows energy resources to be pooled from a variety of sources including but not limited to fossil fuels, renewable resources, nonrenewable resources, and any fathomable means of creating electrical current. With this in mind, this application covers any implementation, usage, modification, alteration, functional purpose, or operation via the technological device described herein for the purpose of disinfecting, purifying, or otherwise inactivating pathogens or microorganisms via the usage of battery power. Such domain includes and is not limited to any feasible means of charging or recharging said battery device and any manipulation of the battery's operational, functional, or otherwise properties inherent to the battery itself.

Vehicular Motor Applications—one widely available resource within the developing world includes motor vehicles, specifically but not limited to motor bicycles, motorized three wheel vehicles, or motorized four wheel vehicles. In order to run the combustion engine within each of these motorized vehicles, a battery, typically though not explicitly using a 12V or 24V battery, is necessary in order to help power this apparatus. Recognizing this, we seek to protect the intellectual property that would allow the battery operations or motorized combustion engines of these vehicles to power this technological invention. Even in the acquisition of acquiring renewable energy or fuel-based energy, batteries are pertinent for ensuring enough electricity can be provided to the ultraviolet lighting mechanism in the demand needed. As automobiles have this readily available electrical resource and are in high abundance in many resource-scarce settings, we recognize that manipulations to our technological innovation could be taken in order to utilize this resource. Additionally, as a motor vehicle will be used regardless of powering this device or not, the small pull of energy taken from this battery can be used in emergency circumstances irrespective of alternative power supplies without draining the motorized vehicle's power supply. Given the combustion engine of most motorized vehicles also recharges these automobile batteries, this resource can be continuously recharged throughout the operation of the car during its intended operational function. With this in mind, this application covers any implementation, usage, modification, alteration, functional purpose, or operation via the technological device described herein for the purpose of powering this device using any powering operation housed within any multi-wheel, functioning, or nonfunctioning automobile.

Independent Applications—outside of energy applications, this system can offer sustainable and durable purified water resources via individual, household-level purification. By implementing this device on a household-by-household level, this device can be utilized for smaller volumes across shorter operational timelines to allow for the device to last over longer time periods. In other words, by implementing this device on a small scale, the minimal operations taken by one family for purified water will allow this technology to have a longer operational usage before needing repair or replacement. As the lamping mechanism can start and stop rapidly with a baffling design that minimizes the exposure time necessary for water resources, purification of water can easily be used only when needed. As the device does not have to run continuously, the lamping mechanism will only need to be run on an average of a few minutes to hours per day. With an estimated number of operational hours on the order of approximately though not narrowly defined as 16,000 hours, this system can easily enable operations to take place for a few thousand days before replacement or repair. As such, individual applications may allot for usage over a series of years with minimal maintenance across that time period. Given this operational timeline, the initial investment for such a system dramatically decreases per cycle of operation and over the entire lifetime of product usage. This in turn allows for the individual application of such a system to be extremely cost effective and beneficial to the consumer rather than for the profiteering of any distributor. With this in mind, this application covers any implementation, usage, modification, alteration, functional purpose, or operation via the technological device described herein for the purpose of personal or individual household-level applications.

Communal Applications—in the event that individual, household level implementation of this technological device poses too great an energy, finance, resource, or otherwise burden on the owner, such a system can be co-owned for community-level operations. Similar to the pooling of financial resources in the case of insurance pooling, this implementation allows for purified water to act as a communal resource at the disposal of all individuals dwelling within the confines of this community (whatever the spatial definition of said space may be). By sharing the costs, maintenance, and operational oversight of the technological device in this capacity, this system succeeds in providing widespread access to an otherwise scarce resource, allowing for communal-based indirect benefits. Such a device and the divisional responsibility and opportunity arising therein can provide improved communal impacts including but not limited to more equal power sharing, reduced tensions along ethnic divisions, reduced strain on public utility systems, reduced strain on public healthcare systems, and increased economic and commercial market stimulation via increased disposable income at the household level. With this in mind, this application covers any implementation, usage, modification, alteration, functional purpose, or operation via the technological device described herein for the purpose of increasing the opportunity for improved communal (loosely defined as any dense population of individuals dwelling within the same geographical location) access to purified water resources.

Corporate Applications—outside of community based applications, this technology can be highly valuable at the corporate or commercial level to reduce the public utilities costs found within large scale corporations. Rather than having to outsource purified water, these organizations can treat and disinfect water at the point-of-exit within their own facilities, maximizing the cost effectiveness and efficiency of providing purified water resources to their customers, clients, staff, or others interacting within the confines of their corporation's property. Though possibly on minimizing a small amount of costs for each usage of water resources, these modules in combination across a high demand can provide accumulated accruement of financial savings. Such a technology may also allow for increased capacity by the corporation to accommodate other water-related activities including but not limited to means of hygiene, sanitation, washing, consumption, culinary purposes, agricultural purposes, or improvements in individual health. With this in mind, this application covers any implementation, usage, modification, alteration, functional purpose, or operation via the technological device described herein for the purpose of improving, altering, decreasing costs, decreasing energy demand, or increasing purified water resources within any corporation, business, or other entrepreneurial venture.

Air Applications—up to this point, all descriptions provided herein discuss the disinfection of water-related resources to provide purified water. That said, we recognize that this apparatus has the capacity to be utilized for further purposes including but not limited to alternative sources of fluid, water vapor, atmospheric air, or any gaseous/fluid mixture of any composition. Though all calculations herein are designed upon the germicidal irradiance of ultraviolet light through water, we do not neglect the fact that such applications may be useful for other fluid or gaseous mixtures and compounds for any of the aforementioned applications or following fields of invention. In fact, discussion among the research team has already begun for the establishment of such a baffling mechanism for the purification and disinfection of alternative fluids and gases within and beyond the applications and fields of invention described within this application. With this in mind, this application addresses any implementation, usage, modification, alteration, functional purpose, or operation via the technological device described herein for the purpose of disinfecting, purifying, or otherwise inactivating pathogens or microorganisms through any non-water fluid or gaseous mixture or compound.

Monitoring and Evaluating Applications—while this technological invention intends to be implemented within the field, optimization of such a design must include all applications for monitoring and evaluating this system's success. To ensure effective functionality, operability, and future adaptability to a wide variety of environmental conditions, this system must have the ability to be rigorously evaluated and monitored for real-time data analytics. In order to achieve this, the system will need to incorporate variations including but not limited to micro-controllers, micro-sensors, and other data analytics deemed pertinent for optimizing the performance of this system within the field of application. Once acquiring this data, manipulations of recorded information therein can be applied for any number of conceptual reasons. Rather than claim ownership of any data recorded or collected therein, embodiments seek to obtain control over any manipulations made to the system to allow for increased understanding of the operability or functionality of the system, regardless of whether collected information parallels the functional goals inherently discussed above. With this in mind, this application covers any implementation, usage, modification, alteration, functional purpose, or operation via the technological device and data analytics recorded or obtained within this device or the system components joined in addendum therein.

The following sections from [0149] through [0162] takes into consideration all plausible applications for this technological invention. Though these verticals are not exhaustive by any means, they do provide the primary functions for which this technological innovation is intended to be utilized for. Recognizing that the innovation for this patented invention is equally as valuable in its technical specifications as it is in its conceptual, functional, and operational capacities, these fields of invention are important for understanding and maximizing the overall impact of such a system. At the same time, by listing and describing in details these verticals, intellectual property domain can be spread to the fullest extents of these bounds. Taking this into consideration, all following fields should be included in the intellectual property rights under this patent application.

Medical Center Vertical—Medical centers are rendered less effective when they do not have access to purified water. While medical centers may be able to supply proper medications, the effectiveness of overall healthcare can be nullified by a lack of sanitary water. Especially in the developing world, medical centers may function as pharmacies without an associated infrastructure to support the application of their pharmaceuticals for their patients. In these cases patients have access to proper medications but not to the purified water they need to take them. If a patient uses unsanitary water to take pills, the negative effects of the unsanitary water will likely outweigh the positive effects of the medicine, including but not limited to vomiting or diarrhea from a waterborne infection. Also, proper water and nutrition help to bolster the effects of all medications. By providing medical centers with purified water, we could expand their capability to provide holistic patient care as opposed to strictly pharmaceutical care, ultimately increasing the overall health of those who use the medical center. With this in mind, this application covers an application of the technology described herein when operated within a medical center setting.

Hospital Vertical—By providing hospitals with purified water, we hope to prevent waterborne illness in hospital settings. Purified water allows for a reduced potential of nosocomial infection by means including but not limited to increased sanitary cleansing of wounds, sanitation of bed linens, and general sanitation of the hospital. Most importantly, purified water can be consumed by patients and used in the preparation of their food, so that nutrition can be a complementary factor in patient recovery as opposed to a means of introducing further health concerns. These points are especially important for patients who have become immunocompromised by their ailments. Ultimately, the introduction of purified water stops the spread of nosocomial infections and allows the hospital to develop more fully as an institution of healing without the hindrance of acting as a hotbed for the spread of infection and disease. With this in mind, this application covers application of the technology described herein when operated within a hospital setting.

Public Health Vertical—Waterborne infectious diseases pose a massive threat to public health due to their ability to spread quickly through and between communities. Particularly, we are concerned with communal sources of water that can act as an infection site for large numbers of individuals. Such examples include a single well from which an entire community draws or a single faucet as was the source for the Cholera epidemic in Europe. These sites have the capability to harm an entire community at any given time, and that community, in turn, becomes liable to infect further communities, and so on, potentially creating an epidemic. By providing purified water in such communal settings, we hope to limit large-scale infections through waterborne diseases; thereby limiting public health concerns and relieving stress off of the medical infrastructure, including but not limited to medical centers and hospitals. With this in mind, this application covers an application of the technology described herein when operated within a public health and communal setting.

Urban Planning Vertical—Rainwater runoff, and more generally precipitation runoff, represents one of the largest untapped resources for our water purification system. In directly purifying runoff for human consumption, we would be fighting the problem of limited clean water while simultaneously relieving stress on wastewater management systems. Such alleviation to treatment facilities serves many purposes, especially in urban settings, including but not limited to decreasing the volumetric influx of water to wastewater management facilities, decreasing the stress on groundwater resources, and decreasing the market price for commercial water sales. Additionally, because most wastewater management systems ultimately terminate water resources in the ocean, our system would help return water resources to the soil, thus, improving overall soil health and increasing agricultural potential. With this in mind, this application covers an application of the technology described herein when operated within an urban planning setting.

Agricultural Vertical—Agriculture is a locus for the indirect spread of infectious disease. Through the process of bioaccumulation, unsanitary water, introduced through irrigation, can cause toxins and pathogens to be stored in plant tissues. Especially in the case of plants with large vascular systems, these toxins can accumulate in higher volumes as well as disperse through much of the plant tissue within a plant. These pollutants can then be transferred to humans upon consumption, leading the spread of infectious disease in everyday food consumption. By providing purified water, which can be used by agriculturalists, our system can help to reduce infectious disease from being introduced to crops by irrigation systems, ultimately stopping the spread of those diseases to the peoples who survive off of these agricultural products. With this in mind, this application covers an application of the technology described herein when operated within an agricultural setting.

Nutritional Vertical—As stated above in [0154], nutrition is an essential component of various health concerns. However, most importantly nutrition is important for its own sake. Consumption of food that is contaminated by unpurified water poses one of the most fundamental threats to public safety. Our system could provide purified water which could be used to fulfill WASH protocols by keeping various food preparation centers sanitized (through similar means as listed under the hospital vertical). Also it could prevent the spread of waterborne diseases in cooked foods. Purified water provided by our system could especially combat the production of thermotolerant pathogens, which adapt to the temperatures used in cooking. This would then eliminate those pathogens before they ever reach the cooking stage of food preparation and adapted to become thermotolerant. Ultimately, our system would allow people to obtain the nutrition they need without the risk of contracting and spreading waterborne diseases. With this in mind, this application covers an application of the technology described herein when operated within a nutritional context.

Marketplace Vertical—Oftentimes in the transportation of harvested crops from agricultural fields to the marketplace, this produce can become contaminated or soiled, especially when transportation lacks enclosed packaging. With this in mind, the marketplace vertical focuses on utilizing purified water resources to remove potential contamination of agricultural produce within marketplaces. By having access to purified water, produce can be cleaned and washed after harvest and transport, preventing consumers from purchasing contaminated food items. Additionally, as water is needed to keep produce fresh, any contaminated water used to ensure the continued shelf-life of the produce could further contaminate this food source. Such a notion parallels those mentioned in the agricultural vertical described in [0154] whereby abrasions on foodstuffs that collect contaminated water can further spread contamination to individuals. Outside of traditional washing of produce, this vertical also includes but is not limited to the application of water via dosing, spraying, soaking, rinsing, or any means by which water comes into contact with agricultural foodstuffs. With this in mind, this application covers an application of the technology described herein when operated within a commercial marketplace setting.

Military Vertical—In the case of militaristic operations, water can be an extremely limiting factor in the success or failure of armed soldiers. Such inhibitions that can come from a lack of water resources includes but is not limited to inadequate nutrition, poor health quality, increased immune system deficiencies, increased infection, lack of field operation capacity, and simple needs for health, hygiene, or culinary purposes. With this in mind, our technological innovation has the capacity to provide purified water resources at any point in a military operation as long as that operation has access to some water resource. As such, this device can enable the replenishment of water resources over time and allow for the restocking and supplying of water resources across various intervals along a mission. As the system can maximize purification in a short period of time, water resources can be replenished in larger volumes quicker than other competitive water purification designs. With this in mind, this application covers an application of the technology described herein when operated within a military supply line or field operational setting.

Educational Vertical—especially found in developing or low-resource settings, water insecurity can promote insecurity of communal education, most prominently among women and children. In some settings, lack of access to purified water supplies within education systems prevent the wide-scale operations of the school itself. Alternatively, schools where contaminated water is used despite its cleanliness poses increased health risks on a more susceptible population of youth. For this population, health hazards and waterborne diseases can result in long term emotional, cognitive, psychological, physical, physiological, and neurological impediments. Additionally, lack of access to secure water resources can induce an indirect consequence of water insecurity namely limited education for women and children. As water resources must be collected by this subset of the population, youth are not exposed to education which can then result in consequences including but not limited to less opportunity for income, increased potential crime rates, and less exposure to public health and safety information. This last reasoning, exposure to public health information, compounds the issue of water insecurity as individuals are then not trained or learned in water health, safety, and hygiene protocols. With this in mind, this application covers an application of the technology described herein when operated both directly and indirectly within an educational setting.

Women/Child Empowerment Vertical—expanding upon the mentionings of [0158] above, water security largely falls as a burden upon women and children in underdeveloped and resource-scarce settings. These circumstances cause these two subsets of the population to experience increased drudgery including but not limited to traveling far distances to obtain water, carrying heavy loads of water across these distances, minimizing personal consumption/usage of water for male figures, social outcasting or diminishing social value due to unacquired water resources, and increased health risks due to the lack of necessary clean water to attend to biological processes (including but not limited to menstruation, childbirth, and vaginal care). That said, clean water, especially purified water at a local source point potentially even within the home of the women and children themselves, can increase the empowerment of these populations within the typical fabric of society. By increasing the access of a more hyper-localized water resource, women and children experience less drudgery and consequences therein from being required to obtain these water resources. With this in mind, this application covers an application of the technology described herein when operated both directly and indirectly for the purpose of empowering or reducing the drudgery upon women and children.

Environmental/Humanitarian Emergencies Vertical—the terminology included herein combines the need for purified water to accommodate for natural disaster emergency aid as well as humanitarian relief in the case of humanitarian emergencies. In the case of environmentally-related and environmentally-induced disasters, clean water is imperative to ensure the survival of all affected individuals. In some cases, these disasters can reduce access to or completely stop the provision of public utilities including water, impacting activities including but not limited to consumption, hygiene, sanitation, culinary purposes, or health purposes. With that in mind, on-the-ground access to purified water resources is imperative as is an apparatus that can help take acquired, possibly contaminated water resources and purify them. Along these same lines, humanitarian emergencies also jeopardize access to clean water, especially in the case of political violence, war, or other forms of conflict. In these humanitarian emergencies, clean water can also be of limited access due to minimal public utility provisions. Additionally, clean water resources being in such small supply, can cause water to become a means of power of one person or group over another person or group. Such impacts can result in the consequences including but not limited to starvation, forced servitude both sexual and otherwise, forced acquisition of military arms, or increased prevalence of violence and crime. With this in mind, this application covers an application of the technology described herein when operated both directly and indirectly for the purpose of mitigating the impacts of natural disasters or humanitarian emergencies.

Home Improvement Vertical—in an extremely simple matter, this device can easily be used for the improved home living and daily operating of an individual within his/her household. Even in areas without resource scarcity, such an apparatus may be utilized to provide another layer of safety and protection to the homeowner. Even if such disinfection unit may not provide much additional microbial inactivation or water purification, such a device could provide increased psychological benefits or utility benefits to the owner. As such, this system can function not to create opportunity for which clean water can exist, but rather improve the livelihoods of individuals where water already exists. This improved livelihood can then offer the opportunity for indirect benefits including but not limited to greater productivity, increased security, and higher home health living standards. With this in mind, this application covers an application of the technology described herein when operated both directly and indirectly for the purpose of improving home-based living conditions.

Manufacturing Systems Vertical—the final vertical for which this device intends to be impactful is in the processing and purification of water resources used in manufacturing processes. Across sectors including but not limited to industrial, chemical, biological, or machine-based manufacturing, water is typically used as a fluid in the overall production process. Whether serving purposes including but not limited to a catalyst, a cooling agent, a solvent, or simply for cleaning of a product throughout its manufacturing process, water is often used in large volumes. Once used, this brackish water is often disposed of in effluent waste streams or directly released to the environment. Rather than requiring this form of disposal, this technological device can be used to reduce the rejection of manufacturing brackish water and instead recycle said water in the manufacturing process. In doing so, advantages include but are not limited to the reduced usage of water resources, the increased savings by manufacturing centers, and the improved environmental impact of water on this surrounding environment. With this in mind, this application covers an application of the technology described herein when operated both directly and indirectly for the purpose of any manufacturing sector for which water is used at any point within a production operation.

What we claim is:

1. An apparatus, comprising:
an ultraviolet light source; and
a water chamber utilizing a helical spiraling of a hand- or automated-screw structure encircling at least partially around the ultraviolet light source to maximize the ultraviolet transmittance and minimize exposure time for thorough ultraviolet germicidal water purification of water within the water chamber.
